(19) United States
(12) Patent Application Publication
(10) Pub. No.: US 2018/0189819 A1
(43) Pub. Date: Jul. 5, 2018

(54) SYSTEM AND METHOD FOR TRACKING IN-STORE DISPLAYS

(71) Applicant: Blue Calypso, LLC, Richardson, TX (US)

(72) Inventor: Andrew E. Levi, Dallas, TX (US)

(73) Assignee: Blue Calypso, LLC, Richardson, TX (US)

(21) Appl. No.: 15/398,633

(22) Filed: Jan. 4, 2017

(51) Int. Cl. G06Q 30/02; G06Q 10/08; G06Q 10/06; G06Q 10/00

(52) U.S. Cl. CPC G06Q 30/0241; G06Q 10/087; G06T 19/006; G06Q 10/20; G06Q 10/06316

(57) ABSTRACT

An apparatus and method of use is disclosed for tracking and interacting with in-store displays. A system is provided which utilizes active GPS positioning and streamed video interaction to deploy, maintain, restock and retire in-store displays. A display is provided that comprises a dedicated controller for operating sensors and video displays which interact with a consumer device based on proximity and consumer interaction and which interact with the system to aid in tracking the correct positioning and maintenance of the in-store display.

### BACKGROUND AND SUMMARY

Brick and mortar retail stores often rely on attention grabbing mechanisms to compete for and hold customer attention. In-store displays and end cap displays are examples of these mechanisms. They are used to capitalize on the physical presence of the consumer in the store to promote and enhance sales of products.

The use of in-store displays is perceived to provide a competitive advantage that increases product awareness and sales velocity. Products on in-store displays typically sell faster and in greater numbers than products on normal shelves in the store.

In-store displays are typically standalone structures that incorporate racks for products and various static advertising features to promote impulse purchasing. Displays are often portable and can be reusable or disposable. If disposable, a display generally has a useful lifetime and is then retired. If reusable, the display must be periodically restocked and maintained. Display structures are usually designed for indoor use, but can be adapted to outdoor conditions.

Referring to FIG. 1, in-store displays often are a part of larger advertising campaigns. Advertising campaigns are designed to include many coordinated facets to attract customer attention. For example, incentives and signs are often displayed through the lifecycle of the campaign. Campaigns also have defined beginning and ending dates. In-store displays are set to be deployed at the beginning dates, interacted with by the consumers, if applicable, restocked during the campaign and then collected or “retired” at the end of the campaign.

Despite the advantages of in-store displays, many challenges exist in their deployment, stocking and retirement. First and foremost, in-store displays are expensive to place in a retail environment. Display space is often leased or funded monthly by the retailer. Therefore, it is important to minimize the time and effort required for proper deployment of the display and maximize the exposure of the customer to the display. It is also important to track the deployment of the display to make sure it is on time and on location so that the campaign appears coordinated to the consumer.

Upon deployment, at the beginning of a campaign, the displays are supplied to distribution teams. The distribution teams may have dedicated routes each having responsibility for several retail stores. The displays are typically deployed in a pre-defined form designated by the retailer. The displays are assembled at the retail store and placed in specific locations. However, in the prior art, the displays often lack coordinated instructions for assembly and effective tracking of deployment.

Maximizing customer interaction during an advertising campaign is important. One important aspect of customer interaction is visible contact with the display. Visible contact is directly related to a consistent physical location within the store. However, in the past there is a lack of consistent placement of displays and a way to routinely and regularly track display placement by the retailer, brand owner, or distribution team.

In-store displays must be restocked or “merchandised” often and maintained in order to maximize sales velocity. A distribution team or retailer usually maintains and restocks the in-store displays in order on the route. This method of restocking is often inefficient, leading to wasted time and lost sales because in-store displays that need restocking are often not restocked until they are reached on the route. Further, displays which are in need of maintenance or repair are often not serviced until the problem is recognized by the distribution team. The result is that damaged displays remain in service longer than desired, again reducing sales effectiveness.

At the end of an advertising campaign, displays must be disassembled and retired. The distribution team usually disassembles the in-store displays in order on the route. However, tracking of retired in-store displays is not always available because they are often discarded at the retail location after disassembly. Further, lack of prompt retirement at the end of an ad campaign promotes customer confusion in the marketplace and lost sales. Tracking of retirement is important to solve these problems.

Despite the effectiveness of in-store displays as a sales tool in the past, customer interaction with retail stores is changing. With the advent smart phones, the Internet and online advertising, increasing numbers of products are now sold online. Online sales have reduced the foot traffic in retail stores and so have also reduced the overall contact that mass consumers have with in-store displays.

Many factors have facilitated the rise of online sales of goods. For example, the ease of delivery and readily competitive pricing appealed to consumer's desire for easy shopping. Furthermore, the ready access to the Internet through mobile computing and most importantly, smart phones, have empowered consumers to conveniently display and purchase products rapidly and with a wide variety. Smart phones have been pivotal in the change to online purchasing because they easily commandeer the attention of the shopper. For the most part, retail stores have failed to tackle the technical problems required to incorporate the smart phone technology into the in-store display and so have failed to capitalize on the availability of online mechanisms to capture customer attention when they are in-store and on a path to purchase.

The prior art has failed devise a system which incorporates the advent of mobile computing and smart phones into the display. As a result, prior art displays are less efficient and less effective than they could be in attracting customer attention and consummating in-store sales.

The prior art has also failed to provide a method for adequately assuring brand marketers that in-store displays are assembled correctly, located correctly, stocked and maintained correctly, and retired correctly, so as to provide meaningful feedback and tracking.

The prior art has also failed to provide adequate instructions for assembly, stocking and retirement of the in-store displays, resulting in inappropriately assembled or inappropriately stocked displays.

The prior art has also failed to provide a mechanism and system to instruct retail locations or distribution teams to timely remove and retire in-store displays.

The present disclosure provides a technical solutions to increase the efficiency of the installation and use of in-store displays. The technical solutions provided incorporate electronic advertising and tracking of the physical location and condition of the display. The disclosure provides a system which incorporates a dedicated electronic controller actively connecting with a set of sensors and communication devices to provide a virtual and real experience, to both consumers and technicians through coordinated and reactive augmented reality images.

As a result, the system provides coordinated tracking capability for each vendor through the display lifecycle. The system also provides a coordinated experience for the consumer by electronically linking of an image of the physical display to an augmented reality image provided on a smart phone, thereby incorporating the display into the now pervasive online experience.

In another preferred embodiment, the system provides a server based management system for real time tracking of displays throughout a campaign lifetime for the vendor.

In another preferred embodiment, the system provides for location tracking of the in-store displays during the lifetime of the campaign. In one embodiment, GPS location and artificially intelligent image recognition is used to assure proper set up and proper location of in-store displays.

In another preferred embodiment, customer interaction is maximized by use of incentives to motivate customers to participate in a campaign by taking a picture of the display and sending it to the server periodically. The result is an accurate tracking of the position, condition and content of the display which further enhances control and confidence in the effectiveness of the display through the lifetime of the campaign.

In another preferred embodiment, instructions and restocking requests are transmitted from the server to the distribution teams.

In another preferred embodiment, instructions are provided to distribution teams through locally stored video instructions or video instructions provided via streaming media. In another preferred embodiment, instructions are provided by an augmented video image.

In another preferred embodiment, confirmation of installation, placement and retirement is provided by distribution teams through pictures of the in-store displays transmitted to the server and analyzed through artificial intelligence.

In another preferred embodiment, the server can alter the signal transmitted by a beacon or near a field communication chip so as to correspond with consumer interaction with a virtual image.

In another preferred embodiment, the in-store display is provided with processor which can receive instructions from the server and alter certain physical aspects of the display to match campaign parameters.

In another preferred embodiment, the in-store display is used as a target position for a virtual reality image. In this embodiment, a virtual image of a product or incentive is impressed on a video image displayed on a smart phone adjacent to or superimposed onto an image of an in-aisle display. The virtual image may be changed to match a specific, time, product, consumer or advertising campaign or responsive to commands provided by the vendor or retailer.

### BRIEF DESCRIPTION OF THE DRAWINGS

FIG. 1 is a flow diagram of a prior art display campaign lifecycle.

FIG. 2 is a preferred embodiment of a system to control and maximize display effectiveness.

FIG. 3 a preferred embodiment of a display that can be used in the deployment of the system.

FIG. 4 is a diagram of a preferred embodiment of the dedicated display controller.

FIG. 5A is a diagram of a preferred embodiment of the operative components of the technician device.

FIG. 5B is a diagram of a preferred embodiment of the operative components of the consumer device.

FIG. 5C is a diagram of a preferred embodiment of the operative components of the system management computer.

FIG. 5D is a diagram of a preferred embodiment of the operative components of the server.

FIG. 6 is a diagram of a data structure of a server database of a preferred embodiment.

FIG. 7A is a preferred embodiment of display deployment tracking data flow diagram.

FIGS. 7A1 and 7A2 is a preferred embodiment of display deployment tracking data flow diagram.

FIGS. 7B and 7C are a flowchart of a preferred embodiment of an update and start routine of a display controller.

FIG. 8 is a preferred embodiment of a display maintenance and restock tracking data flow diagram.

FIG. 9 is a preferred embodiment of a display retirement tracking data flow diagram.

FIG. 10 is a preferred embodiment of a technician display interactor data flow diagram.

FIGS. 10A and 10B is a preferred embodiment of a technician display interactor data flow diagram.

FIG. 11A shows a coordinate system of a preferred embodiment.

FIGS. 11B and 11C are examples of technician augmented reality displays.

FIG. 12 is a preferred embodiment of a consumer engagement tracking data flow diagram.

FIGS. 12A and 12B is a preferred embodiment of a consumer engagement tracking data flow diagram.

FIG. 13 is an alternate embodiment of a consumer engagement tracking data flow diagram.

FIG. 14 is an embodiment of a consumer engagement flow diagram showing dispersion of controlled content.

FIG. 15 is a preferred embodiment of a consumer display interactor data flow diagram.

FIGS. 15A and 15B is a preferred embodiment of a consumer display interactor data flow diagram.

FIGS. 16A and 16B are examples of a consumer augmented reality displays.

FIG. 17 is a preferred embodiment of a stock level reactor data flow diagram.

FIG. 18 is an example of a preferred embodiment of code to obtain sensor readings.

FIG. 19 is an example of a preferred embodiment of code that computes a bounding box of a marker.

FIGS. 20A and 20B show an example of a preferred embodiment of code used to determine relative movement of a device.

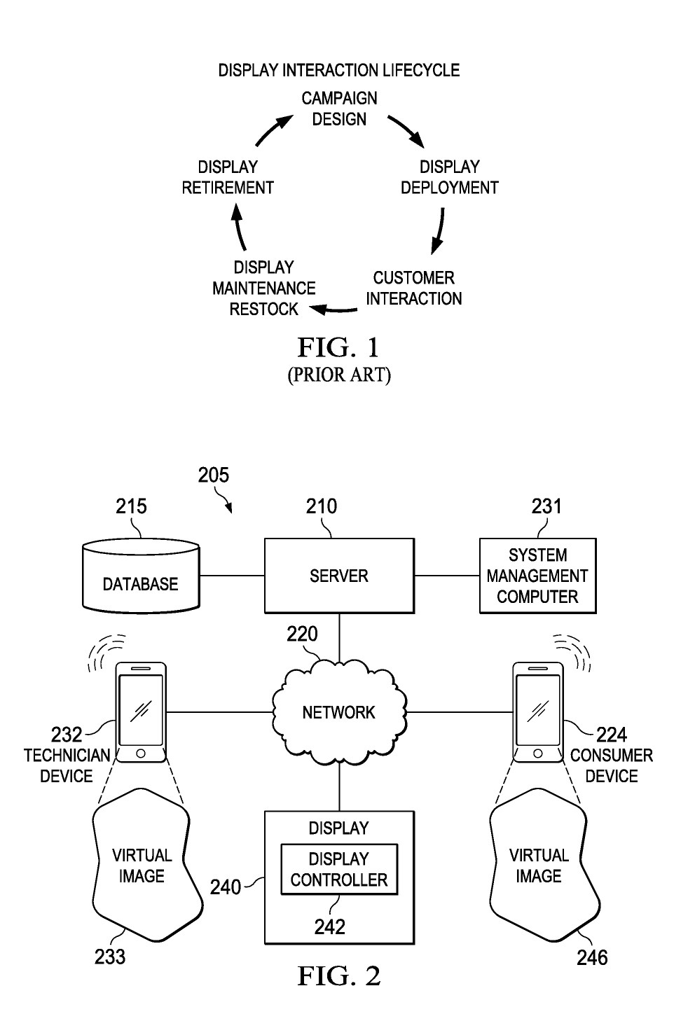

### DETAILED DESCRIPTION

FIG. 2 is a network diagram of one embodiment of the disclosure. System 205 includes network 220 that interconnects various devices. Network 220 includes one or more routers and wired or wireless telecommunications networks, examples of which includes the internet, local area networks, and personal area networks using equipment and protocols that are known. Network 220 allows for communication between server 210, database 215, system management computer 231, consumer device 224, technician device 232, and display 240 with dedicated display controller 242. Consumer device 224 is adapted to display virtual image 246 overlaid on a real time camera image as will be further described. Technician device 232 is adapted to display virtual image 233 overlaid on a real time camera image as will be further described.

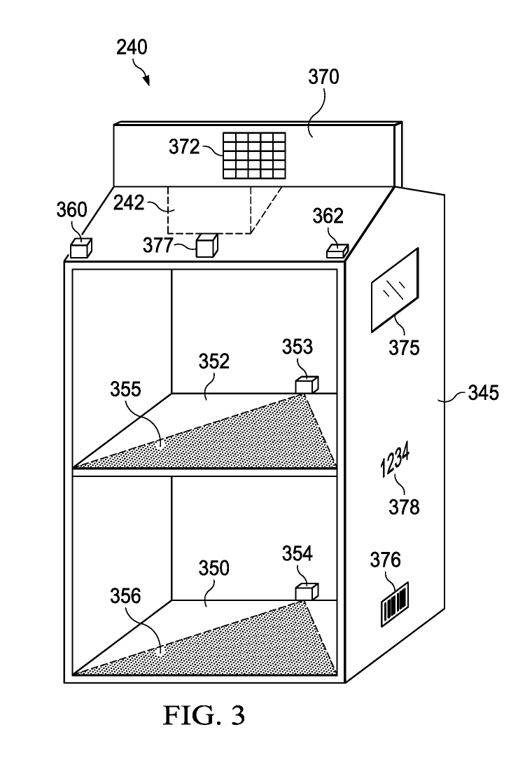

Referring then to FIG. 3, a preferred embodiment of in-store display 240 is described. Display 240 includes a rectangular enclosure 345 including shelves 350 and 352. Shelf 352 includes optical sensor 353. Shelf 350 includes optical sensor 354. Enclosure 345 includes LED stacks 360 and 362. Enclosure 345 also serves as a housing for display controller 242 and display stand 370. HDMI display 375 is mounted in one side of the enclosure. A preferred embodiment, the HDMI display or iPad or Android tablet, such as Samsung Galaxy, may be the Kuman capacitive touch screen display model no. TETLCD. The enclosure also supports barcode 376 and serial number 378. In one embodiment, serial number 378 is the numeric value “1234”. Enclosure 345 also supports near field communication (NFC) tag 377. In a preferred embodiment, the NFC tag is an NXP integrated circuit model DESFIRE EV1 and operates at 13.56 MHz. It is capable of reading and writing 8k bytes of information and is compliant with 150 144438A protocol. In a preferred embodiment, the NFC tag is also ISO 1800-3 and ISO 13157 compliant. Of course, different shapes and sizes of the display are possible, as is the number and arrangement of shelving, sensors, tags, and signage.

Shelves 350 and 352 are provided to support the display of consumer goods such as bags of potato chips or beverages. Optical sensors 353 and 354 read from sight fields 355 and 356. Display controller 242 is operatively connected to LED stacks 360 and 362, optical sensors 353 and 354 and HDMI display 375, as will be further described. Display stand 370 includes optical centering target 372, as will be further described.

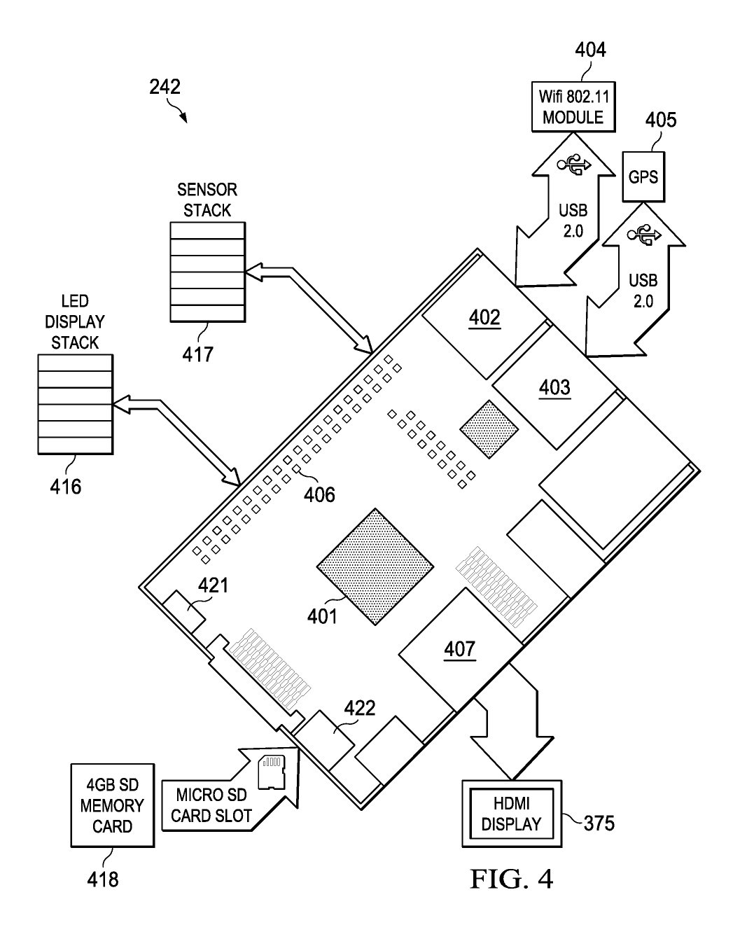

Referring then to FIG. 4, a preferred embodiment of display controller 242 is shown. In a preferred embodiment, the display controller is a dedicated Razberi Pi 3 Model B available from digikey.com. The display controller includes processor 401. In a preferred embodiment, processor 401 is a Broadcom BCM 2837 1.2 GHz Quad-Core processor. Display controller 242 includes two USB 2.0 ports 402 and 403. USB port 402 is connected to WiFi 802.11 module 404 which provides local Internet connection. USB port 403 is connected to GPS Module 405. In a preferred embodiment, GPS module 405 is the Ada Fruit Ultimate GPS Breakout available from Ada Fruit at adafruit.com. The WiFi 802.11 module in a preferred embodiment is Product ID 1012 USB WiFi module 802.11 B/G/N available from Ada Fruit at adafruit.com.

Display controller 242 also includes a HDMI adapter 407 connected to HDMI display 375. Processor 401 is connected to memory card 418 via access slot 422. Code resident on the memory card is used to boot the processor and perform the operations of the display controller, as will be further described. Display controller 242 includes GPIO connector 406. Sensor stack 417 includes optical sensors 353 and 354. Display stack 416 includes LED stacks 360 and 362. Sensor stack 417 and display stack 416 are connected to the processor through the GPIO connector. In a preferred embodiment, the sensor stack includes optical detectors having both an LED and phototransistor on board. In a preferred embodiment, the sensor stack includes four QRD 1114 optical detectors available from Sparkfun at sparkfun.com. The optical detectors provide reflective sensing without the need for separate phototransistors and LEDs.

Display stack 416 comprises an array of five volt LEDs connected through current limiting resistors to GPIO connector 406.

In a preferred embodiment, the display controller is configured as an iBeacon and broadcasts through onboard antenna 421. In another preferred embodiment, the display controller is configured as an Eddystone beacon. In either case, the protocol employed allows a Bluetooth low energy device to broadcast a one way message. In the case of the iBeacon, this protocol is the iBeacon protocol. In the case of any Eddystone Beacon, this protocol is the UID protocol.

Instructions stored in memory card 418 and executed by processor 401 cause display controller 242 of display 240 to interact with system 205. Display controller 242 receives software and updates from server 210 through Wi-Fi module 404. The display controller communicates codes to consumer devices 224 and technician devices 232 as will be further described. In a preferred embodiment, the display controller communicates with server 210 through the internet using wireless module 404.

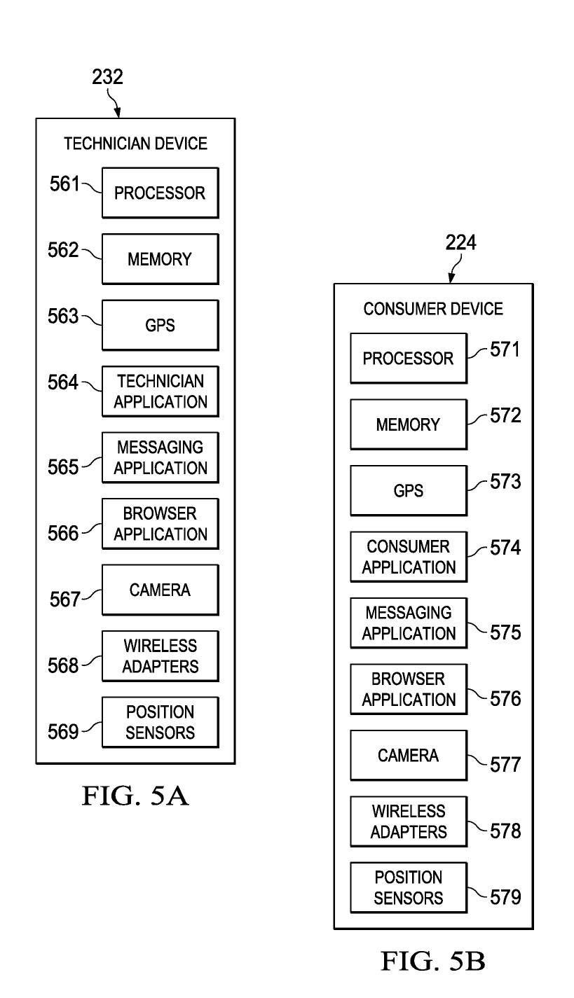

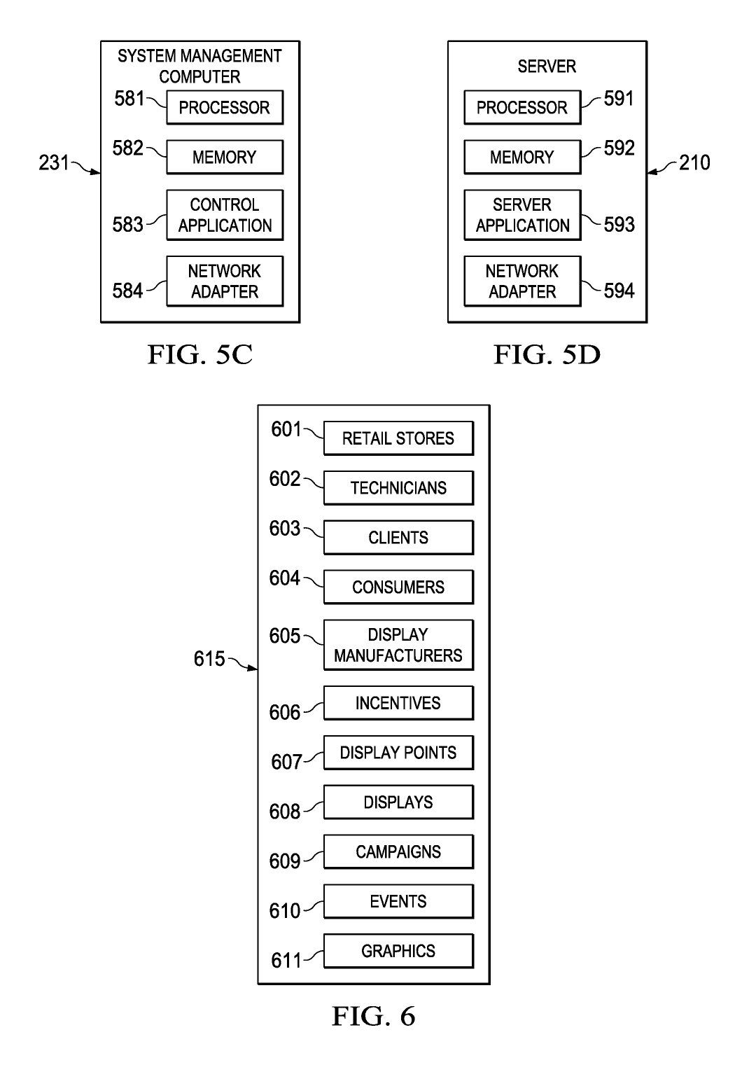

Referring to FIG. 5A technician device 232 includes processor 561, memory 562, global positioning system (GPS) receiver 563, technician application 564, messaging application 565, browser application 566, camera 567, one or more wireless adapters 568, and one or more position sensors 569. Technician application 564 includes instructions stored in memory 562 and executed by processor 561 that cause technician device 232 to interact with system 205. Technician device 232 in a preferred embodiment is a mobile computing device (such as a smartphone or tablet computer) that can be tracked with GPS receiver 563 and can take digital pictures with camera 567. GPS receiver 563 allows location to be tracked and recorded for communication to system 205. Wireless adapters 568 allow technician device to communicate with display controller 242 and other devices connected to network 220.

Technician application 564 includes instructions stored in memory 562 and executed by processor 561 that cause technician device 232 to interact with system 205 as will be further described.

Messaging application 565 on technician device 232 is used to send and receive messages, events, and data within system 205 and can include an SMS application, an MMS application or an email application.

Browser application 566 is used to view web pages from the Internet and accessed via network 220. Data and information from server 210 can be displayed via browser application 566.

Wireless adapters 568 use one or more protocols and standards to establish data communications between technician device 232 and system 205.

Position sensors 569 in a preferred embodiment include a nine axis sensor capable of communicating relative changes in transitional position in three dimensions, rotational position in three dimensions, and changes in acceleration in three dimensions. The position sensors should also include azimuth, pitch, roll, and a magnetic field sensor to determine compass bearing.

Referring to FIG. 5B, consumer device 224 includes processor 571, memory 572, GPS receiver 573, consumer application 574, messaging application 575, browser application 576, camera 577, one or more wireless adapters 578, and one or more position sensors 579. Consumer device 224 is a mobile computing device that can be tracked with GPS receiver 573 and can take pictures with camera 577.

Processor 571 of consumer device 224 allows consumer device 224 to execute one or more applications that are stored in memory 572, such as consumer application 574, messaging application 575, and browser application 576.

GPS receiver 573 allows the location of consumer device to be determined using one or more global navigation satellite systems.

Consumer application 574 includes instructions stored in memory 572 and executed by processor 571 that cause consumer device 224 to interact with system 205 as will be further described.

Messaging application 575 on consumer device 224 is used to send and receive messages, events, and data within system 205 and can include an SMS application, an email application, and an MMS application.

Browser application 576 is used view web pages from the Internet and accessed via network 220. Data and information from server 210 can be displayed via browser application 576.

Camera 577 is integrated with consumer device 224 to allow consumer device 224 to take and record digital pictures.

Wireless adapters 578 use one or more protocols and standards to establish data communications between consumer device 224 and system 205.

Position sensors 569 in a preferred embodiment include a nine axis sensor capable of communicating relative changes in transitional position in three dimensions, rotational position in three dimensions, and changes in acceleration in three dimensions. The position sensors should also include azimuth, pitch, roll, and a magnetic field sensor to determine compass bearing.

Referring to FIG. 5C, system management computer 231 includes processor 581, memory 582, control application 583, and network adapter 584. System management computer 231 displays reports from, and allows for the control of, server 210 via control application 583.

Processor 581 executes one or more programs stored in memory 582. Control application 583 communicates via network adapter 584 and network 220 to server 210. Control application 583 displays information from server 210 based on information and events stored in database 215. System 205 is controlled based on selections received by control application 583 of system management computer 231. Network adapter 584 allows for the connection of system management computer 231 to network 220 and the data communication connection between system management computer 231 and server 210.

Referring to FIG. 5D, server 210 includes processor 591, memory 592, server application 593, and network adapter 594. Processor 591 executes one or more applications stored in memory 592, such as server application 593. Network adapter 594 connects server 210 to network 220 allowing for data communication with the other devices of system 205, such as database 215 and system management computer 231.

Referring to FIG. 6, database 215 is managed by server 210. Database 215 includes a data structure comprised of separate tables that are organized according to content subject matter. For example, in a preferred embodiment, table 615 includes retail stores table 601, technician table 602, client table 603, consumer table 604, display manufacturer table 605, incentive table 606, display point table 607, display database 608, campaign table 609, event table 610, and graphics table 611.

Retail stores table 601 maintains a record for each retail location enrolled in system 205.

Technicians table 602 maintains a record for each technician enrolled in the system.

Clients table 603 maintains a record for each client enrolled in the system.

Consumers table 604 maintains a record for each consumer enrolled in the system.

Manufacturers table 605 maintains a record for each display manufacturer enrolled in the system.

Incentives table 606 maintains a record for each incentive related to system 205. The type of incentives offered to the consumers to participate in the system are stored in the database.

Displays table 608 maintains a record for each display tracked by the system. The type of display, including physical and technical specifications, and of each display are stored in this database.

Campaigns table 609 maintains a record for each campaign related by serial number. The schedule of deployment, maintenance, and retirement of the display are stored here. The number and preferred GPS location of the displays deployed during the campaign are stored here. The preferred distance to target, azimuth, roll, pitch, and magnetic field readings are also stored here. Also, data such as instructional videos, text instructions, virtual images, and wireframe image files are stored or are related to in this table.

Events table 610 maintains a record for each “event” which occurs in the system. In one embodiment, “events” are messages sent between the devices of the system.

Graphics table 611 maintains a set of graphics files, or pointers to files, and menus for display on the HDMI display when certain events take place or when certain messages are received by the display controller.

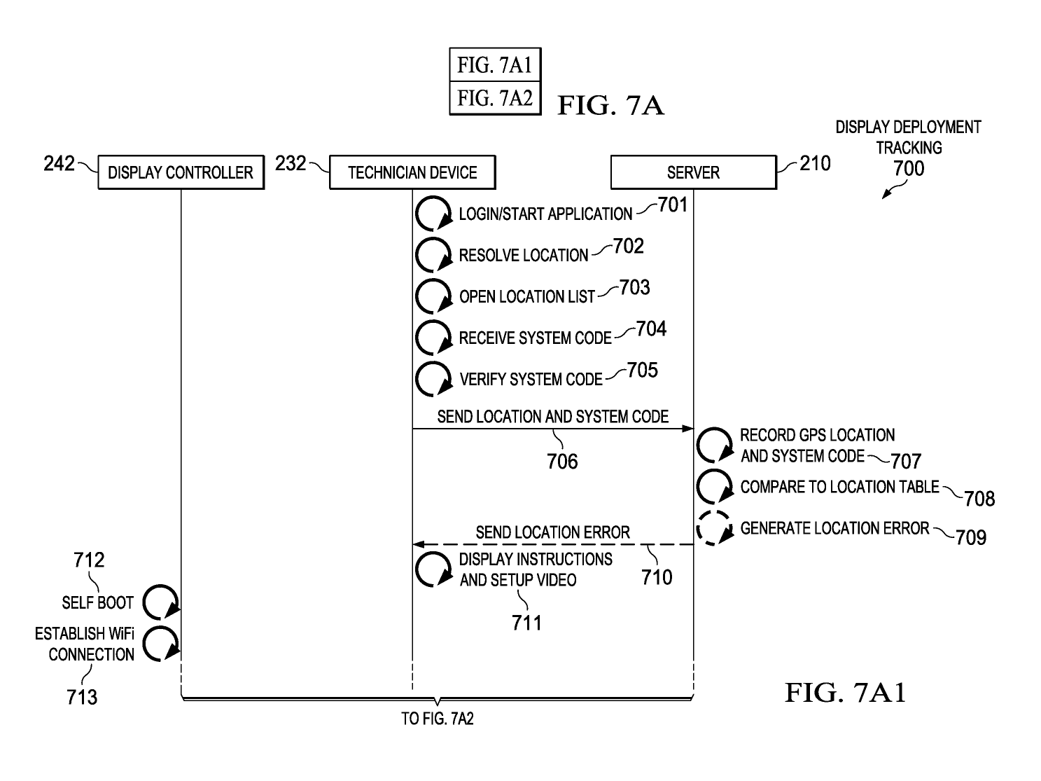

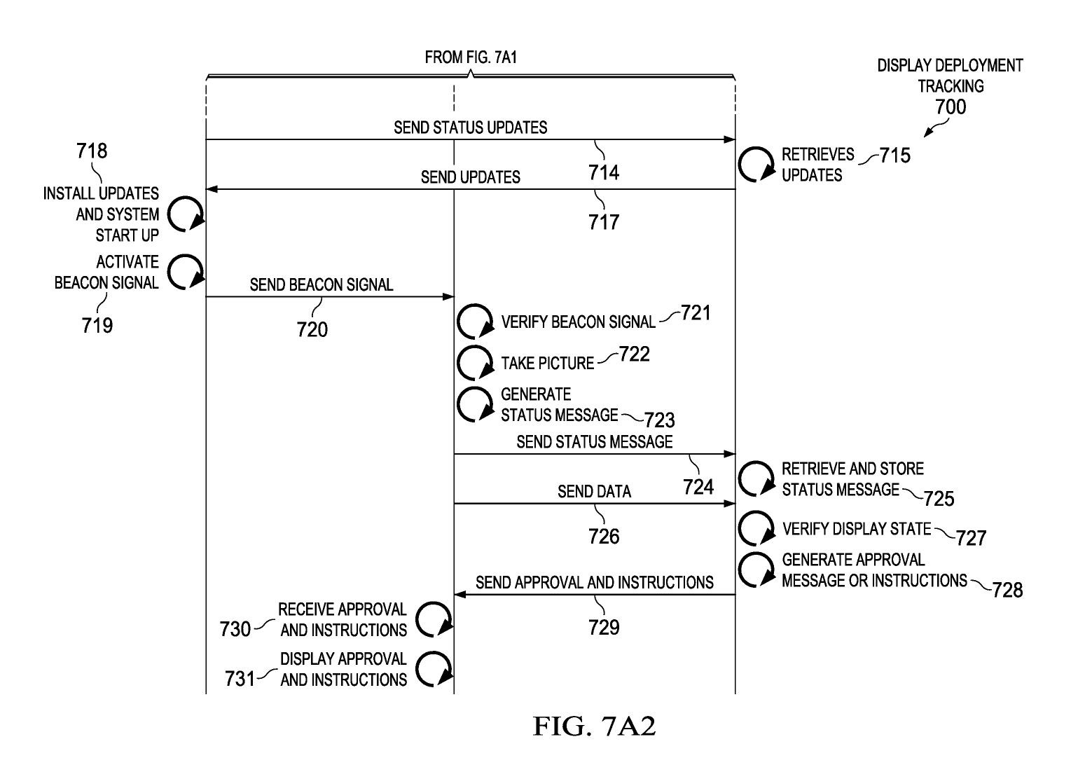

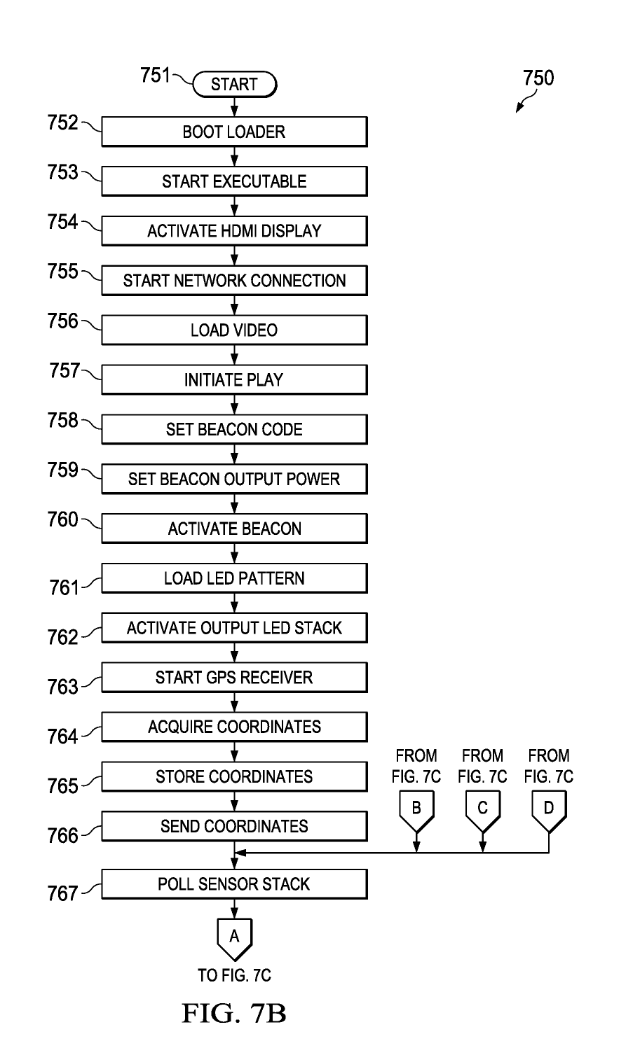

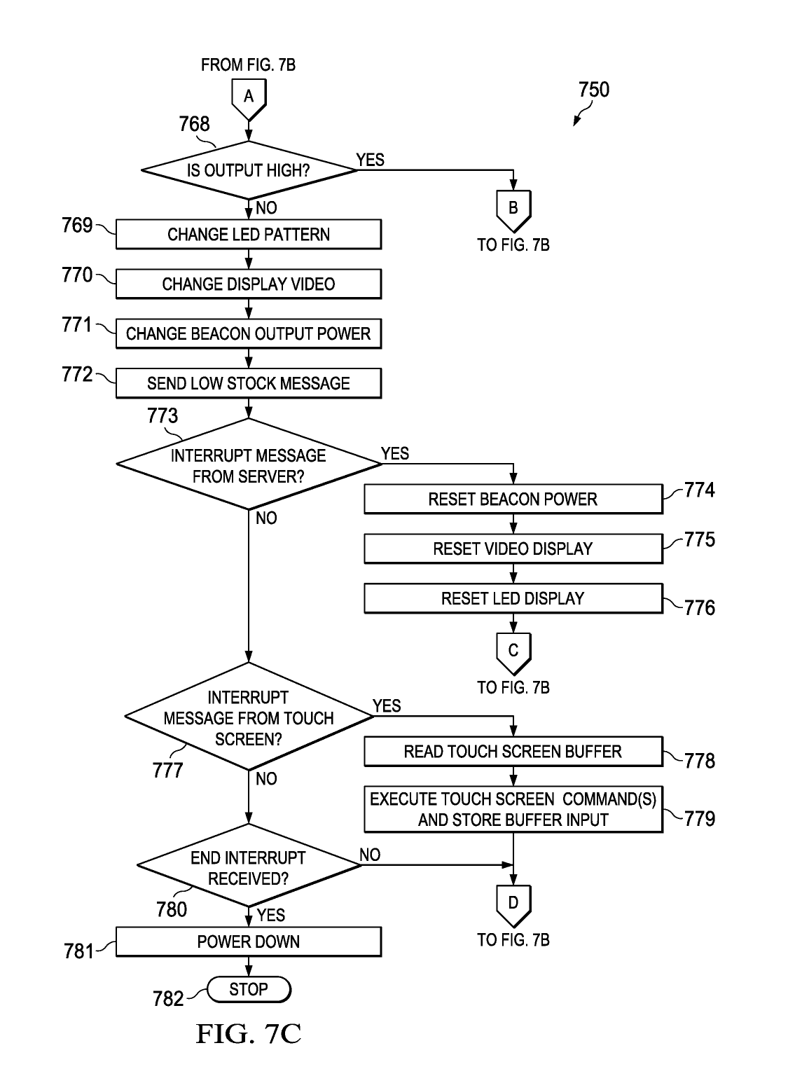

Referring to FIGS. 7A1-7A2, sequence 700 for deployment tracking of a display is described. Sequence 700 involves communication and interaction between several devices of the system, including display controller 242, technician device 232, and server 210.

At step 701, the technician application is started.

At step 702, the location of technician device 232 is resolved by the GPS receiver. The coordinates are stored in local memory.

At step 703, a location list is opened on technician device 232. The location list identifies the location of the store where the display is to be deployed. The location list may include a map and/or GPS coordinates.

At step 704, serial number 378 on the display is entered by the technician. In one embodiment, the code is entered using a keyboard or touchscreen display. In an alternative embodiment, bar code 376 is scanned using technician device 232. In all cases, the code is used to verify the unique number or identity of that display.

At step 705, the serial number is verified. In one embodiment, the display is verified by matching the code to a list of authorized codes maintained in the on board memory of technician device 232.

At step 706, the serial number is sent to server 210 along with the location of technician device 232.

At step 707, server 210 records the location of technician device 232 and the serial number.

At step 708, server compares the location of technician device 232 to the location required for display 240.

At step 709, if the location of technician device 232 is too far away from the required location for display 240, then server 210 generates an error that indicates that display 240 is not at the correct location.

At step 710, if a location error was generated, then server 210 sends the location error to technician device 232.

At step 711, instructions are displayed by technician device 232 for setting up the display. In one embodiment, the instructions include an mp4 video is pulled from the local memory of technician device 232. In an alternate embodiment, the video is transmitted in a streaming format from server 210 to technician device 232. The video can be specific for each type of display and for each location. In another alternate embodiment, a virtual image is projected onto a real time camera image produced by camera 567 to aid in display placement, as will be further described.

At step 712, the process to activate display controller 242 is initiated. A boot program is initiated which pulls instructions from on-board memory of display controller 242. At step 713, display controller 242 establishes a network connection. In one embodiment, this is accomplished through Wi-Fi module 404.

At step 714, a signal is sent from the display controller to the server. The serial number is communicated to the server. At step 715, the server retrieves software updates according to the serial number. At step 717, the updates are sent to the display computer.

At step 718, the display computer installs the updates and performs a system start up, as will be further described. In a preferred embodiment, the LED display stack provides a visual indicator to the technician that the startup is successful.

At step 719, the beacon is activated and begins to broadcast a signal that includes the serial number. A default power setting is used, but may be changed during operation to widen or narrow the reception perimeter.

At step 720, the beacon signal is sent from display controller 242 and received by technician device 232.

At step 721, the beacon signal is verified by technician device 232. The verification matches the serial number in the beacon signal with a serial number stored on technician device 232.

At step 722, a picture of the display is taken by technician device 232.

At step 723, a status message is generated by technician device 232. The status message indicates that deployment of the display was successful or not and whether or not appropriate stocking of inventory in the display has been accomplished.

At step 724, the status message is sent by technician device 232 to server 210.

At step 725, server 210 receives and stores the status message.

At step 726, the picture generated by technician device 232 is sent by technician device 232 and is received by server 210.

At step 727, the state of the display to which the display controller is verified by server 210. In a preferred embodiment, the picture of the display is visually compared to a record stored in the database by an operator. If the operator is satisfied that the condition of the display is suitable, then, at step 728, an approval message is generated. If not, at step 728, instructions as to how to proceed are generated.

At step 729, the instructions are sent from server 210. At step 730, the instructions are received by technician device 232 and acknowledged. At step 731, the instructions are displayed.

Referring to FIG. 7B, the startup routine 750 started at step 712 will be further described.

At step 751, the controller starts a boot loader that initiates system operation at step 752. At step 753, the controller executes the system executable file loaded by the boot loader. At step 754, the controller activates HDMI display 375. At step 755, the controller starts a network connection through WiFi module 404. At step 756, the controller loads an mp4 video found in memory card 418. At step, 757 the controller initiates play of that video.

At step 758, the controller sets the beacon code which will be transmitted when the beacon is activated. At step 759, the system sets the beacon transmission power to midrange. At step 760, the controller activates the beacon and begins transmission of the beacon signal through the antenna 421.

At step 761, the controller loads an LED signal pattern contained in onboard memory. At step 762, the controller activates the LED beacon pattern projecting a light pattern through LED stacks 360 and 362.

At step 763, the controller activates GPS module 405. At step 764, GPS module 405 acquires coordinates for the display. At step 765, the controller stores the coordinates. At step 766, the controller sends the coordinates through the Wi-Fi connection to the server.

At step 767, the controller polls optical sensors 353 and 354. At step 768, the controller compares the output of the optical sensors for a high low decision. If the output is high, then the controller returns to step 767. If the output is low, then the controller moves to step 769 and changes the LED pattern to a different pattern stored in onboard memory and proceeds to step 770. At step 770, the controller changes to a different mp4 video stored in onboard memory. At step 771, the controller increases the beacon power to high. At step 772, the controller sends a low stock message to the server through the Wi-Fi connection. At step 773, the controller checks for an interrupt message from the server. If an interrupt message has been received, the controller moves to step 774. At step 774, the controller resets the beacon power level. At step 775 the controller resets the display video. At step 776, resets the LED display and then returns to step 767. If no interrupt message is received, then the controller moves to step 777. At step 777, the controllers monitor for an interrupt message from touch screen. If the interrupt message is present, then it moves to step 778. At step 778 the controller reads the touch screen buffer. At step 779 the controller executes the touch screen commands as will be further described. The controller then returns to step 767. If no interrupt message is present then the controller moves to step 780. At step 780, the controller checks for an end interrupt. If no end interrupt is present then the controller returns to step 767. If an end interrupt is present, then at step 781 the controller powers down and ends program at step 782.

In a preferred embodiment, touch screen commands can include data entry such as entry of a phone number, customer name, email address, other demographic customer profile information, or shopping preferences. This information entered in response to the touch system commands is stored in the touch screen buffer and then moved to the local memory for use by the display controller.

In another preferred embodiment, the touch screen can serve as a portal to access websites related to the products displayed.

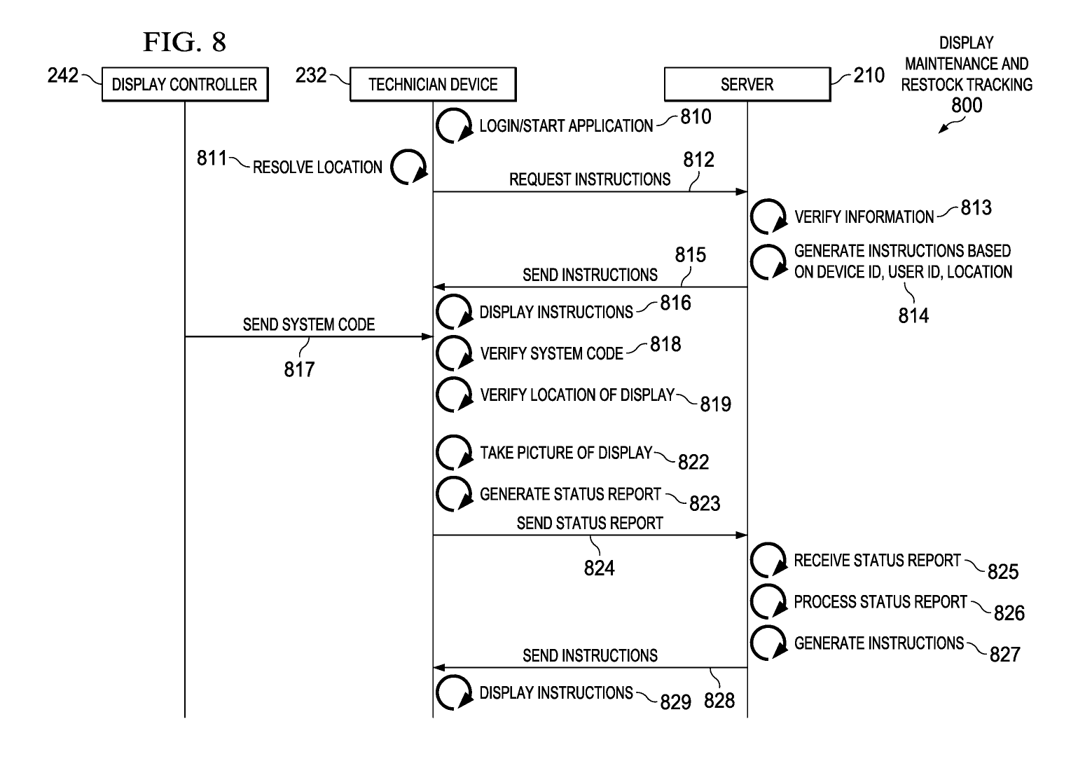

Referring to FIG. 8, sequence 800 describes steps performed by display controller 242, technician device 232, and server 210 to perform display maintenance and restocking tracking.

At step 810, the technician application is started on technician device 232 and the technician logs into the application.

At step 811, the technician device resolves its location using the on-board GPS receiver.

At step 812, a request for instructions is sent from technician device 232 and is received by server 210. The request includes an identifier for the technician device and its GPS location.

At step 813, the identity of technician device 232 and its location is checked by the server against information stored in the database. If it is proper then, at step 814, instructions are generated by the server, as to the activity to be taken by the technician. In a preferred embodiment, the instructions include “maintenance inspection”, “location inspection”, or “restock inspection.” In another embodiment, the instructions include a picture of the display and a map of the proper location of the display in the store.

At step 815, the instructions are sent to technician device 232.

At step 816, the instructions displayed on the technician device 232.

At step 817, the display controller sends a serial number that uniquely identifies the display.

At step 818, the technician devices receives the serial number and verifies that the display is in fact the display intended to be at that location.

At step 819, the technician device verifies that the display is at the correct location.

The location of the display is determined from the current location of technician device 232 and is compared against the expected or last-known location of the display as provided in the instructions.

At step 822, a picture of the display is taken by technician device 232.

At step 823, a status report is generated by technician device 232 that includes data and information collected about display controller 242. The status report includes one or more pictures, the location of technician device 232, the device identifier of technician device 232 and the serial number received by technician device 232 from display controller 242.

At step 824, the status report generated by technician device 232 is sent from technician device 232 and is received by server 210.

At step 825, the status report is received by server 210.

At step 826, the current status of the display is determined based on the status report. In a preferred embodiment, the picture is compared, side by side, with an ideal image of the display by an operator. If the comparison results in a deficiency being identified, then remedial instructions can be sent to the technician device. In another preferred embodiment, an image recognition routine is used by the server to determine if deficiencies are present. The instructions also may include restocking requests with one or more products. In another preferred embodiment, the location of the technician device is compared to the expected location of the display. The location of the display does not match the expected location, then instructions are generated to move the display back to the expected location. In another embodiment, instructions are generated to move the display according to a movement schedule which coordinates the use of the display within the store to the requirements of the campaign.

At step 827, instructions are generated based on the determination of the status of the display.

At step 828, the instructions are sent from server 210 to technician device 232. At step 829, technician device 232 displays the instructions. Presumably, the instructions are carried out by the technician. Steps 822 through 829 can be repeated.

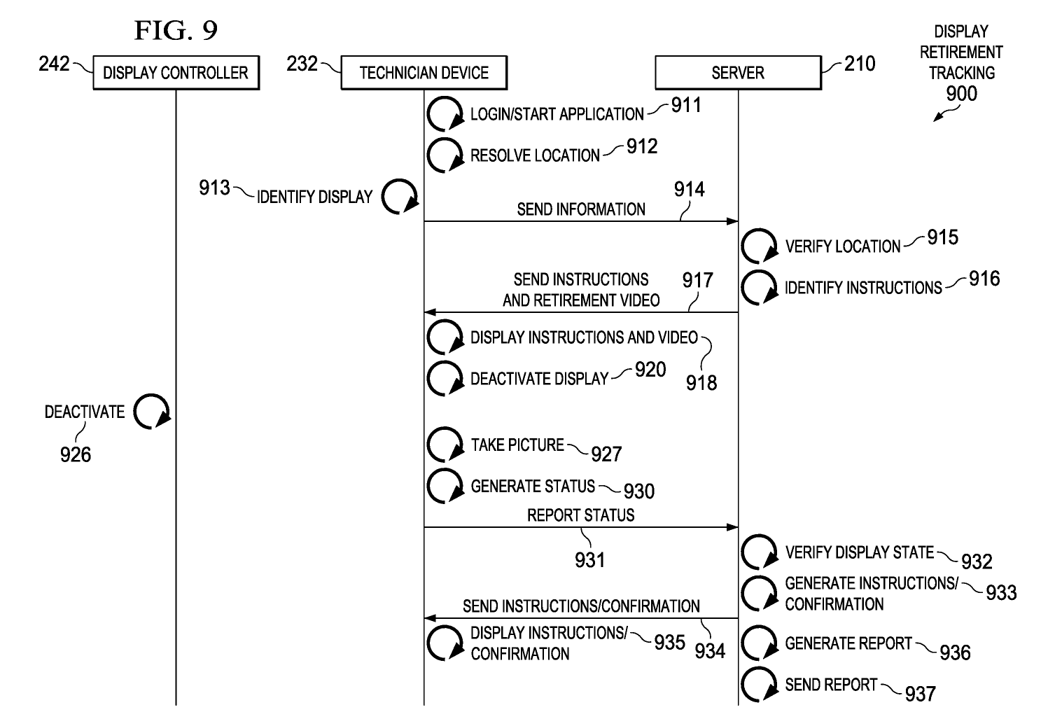

Referring to FIG. 9, sequence 900 describes the steps performed by display controller 242, technician device 232, and server 210 for a technician to track retirement of a display using the system.

At step 911, the technician application is started on technician device 232 and the technician logs in.

At step 912, the location of technician device 232 is resolved. In one embodiment the location is resolved to GPS coordinates. At step 913, the display type is identified by a visual identifier on the display. In one embodiment, the display is identified by a serial number or bar code.

At step 914, the location and display identifier are sent from technician device 232 and is received by server 210 and stored in database 215.

At step 915, the location and display identifier are verified by server 210. If the location and/or display type are incorrect, then a message is sent to the technician device to stop. Otherwise the process continues.

At step 916, instructions are identified by server 210 based on location and the display type.

At step 917, instructions are sent from the server to the technician device. The instructions can include text instructions or a video file that generally describe how to disassemble the display and what to do with it after it is disassembled.

At step 918, the instructions are displayed by the technician device.

At step 920, the process to deactivate display controller 242 is initiated at technician device 232. In a preferred embodiment, the display is disassembled and repackaged for return delivery.

At step 926, display controller 242 is deactivated.

At step 927, a picture of the now retired and packaged display is taken by technician device 232.

At step 930, status information is generated by technician device 232. The status information can include one or more pictures, the location of the technician device and/or display, the display identifier, the technician device identifier, and a date and time.

At step 931, the picture and the status information are sent from technician device 232 to the server 210.

At step 932, the state of the display is verified based on the status reported by the technician device. In a preferred embodiment, the status reported should be “retired.” If so, then, at step 933, further instructions and task completion confirmation is generated by server 210.

At step 934, the instructions and confirmation are sent from server 210 to technician device 232.

At step 935, the instructions and confirmation are displayed by technician device 232.

At step 936, a report is generated by server 210. The report includes the status of technician device 232 and display controller 242.

At step 937, the report may be sent via text message or email to the store owner, manager, retailer, or campaign manager.

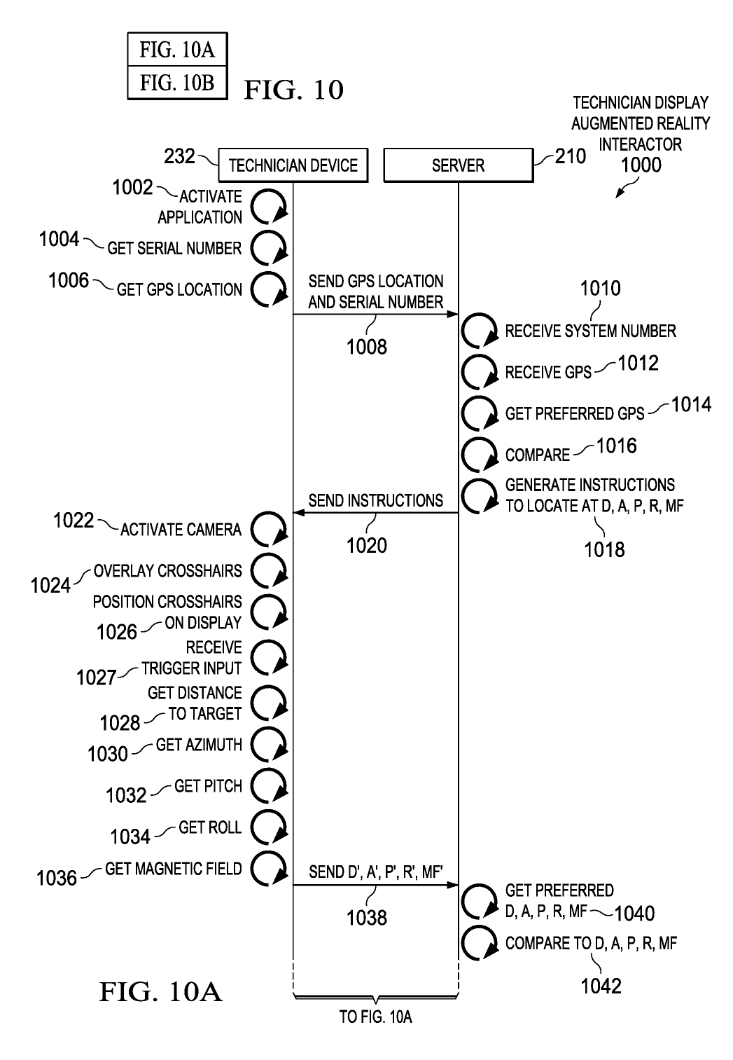

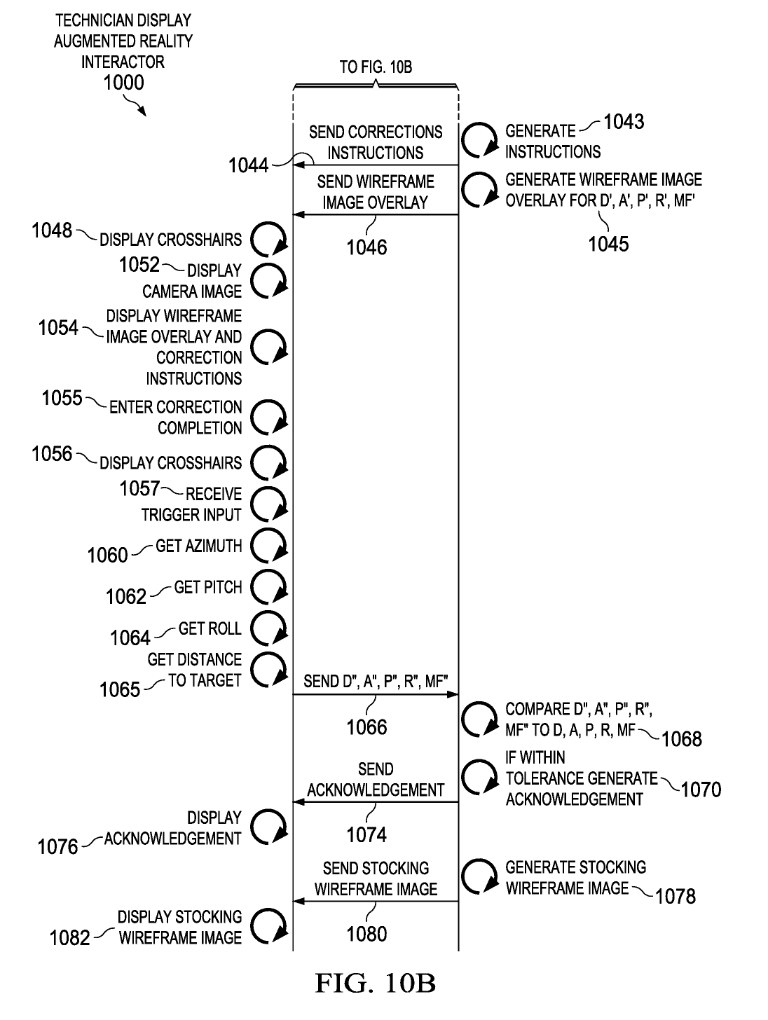

Referring to FIGS. 10A and 10B, sequence 1000 describes the steps performed by the system when a technician device interacts with the display through augmented reality.

At step 1002, an app is activated on technician device 232.

At step 1004, the technician device obtains the serial number from the display. In a preferred embodiment, the serial number is encoded into a barcode on the display that is read by the technician device. In a preferred embodiment, the display bares a readable serial number which is entered into the technician device in a dated field.

At step 1006, the technician device resolves its location via GPS.

At step 1008, the technician device sends the GPS location and the serial number to server 210.

At step 1010, the server receives the serial number.

At step 1012, the server receives the GPS location.

At step 1014, the server queries campaigns table 609 using the serial number to obtain the preferred GPS location of the display. In a preferred embodiment, the preferred GPS location is the location where the display is intended to be, as set out in the campaign instructions.

At step 1016, the server compares the GPS location to the preferred GPS location. If the locations match within a predetermined tolerance, then at step 1018 the server generates a set of instructions, which instructs the technician device to proceed with the augmented display routine. If not, in a preferred embodiment, the server generates instructions which advise the technician device to stop. Other instructions, such as instructions for corrective action are possible.

At step 1020, the instructions are sent from the server to the technician device.

At step 1022, the technician device activates the on-board camera.

At step 1024, the technician device generates a camera overlay image which comprises a set of crosshairs centered in the camera display.

At step 1026, the technician device generates a set of text instructions which are overlaid on the camera image which, in a preferred embodiment, instruct the user to position the camera so as to center the crosshairs on the display.

At step 1027, the technician device receives a trigger input from the user indicating that the crosshairs have been targeted on the display.

At step 1028, the technician device activates a subroutine, which will be further described, which gets the distance to target information representing the distance between the technician device and the display. In a preferred embodiment, the C function call SensorManager.getOrientation( ) is used to obtain the pitch angle “d” of the camera as it is pointed at the base of the display. The following equation is then used:

$$B = \frac{A}{TAN ( d )} \qquad Eq . 1$$

Where:

d=Pitch Angle

B=Distance to Target

A=Camera Height (assumed to be 6 ft)

At step 1030, the technician device activates a subroutine, which gets an azimuth reading from the on-board sensors.

At step 1032, the technician device gets a pitch reading from the on-board sensors.

At step 1034, the technician device gets a roll reading from the on-board sensors.

At step 1036, the technician device gets a magnetic field reading from the on-board sensors.

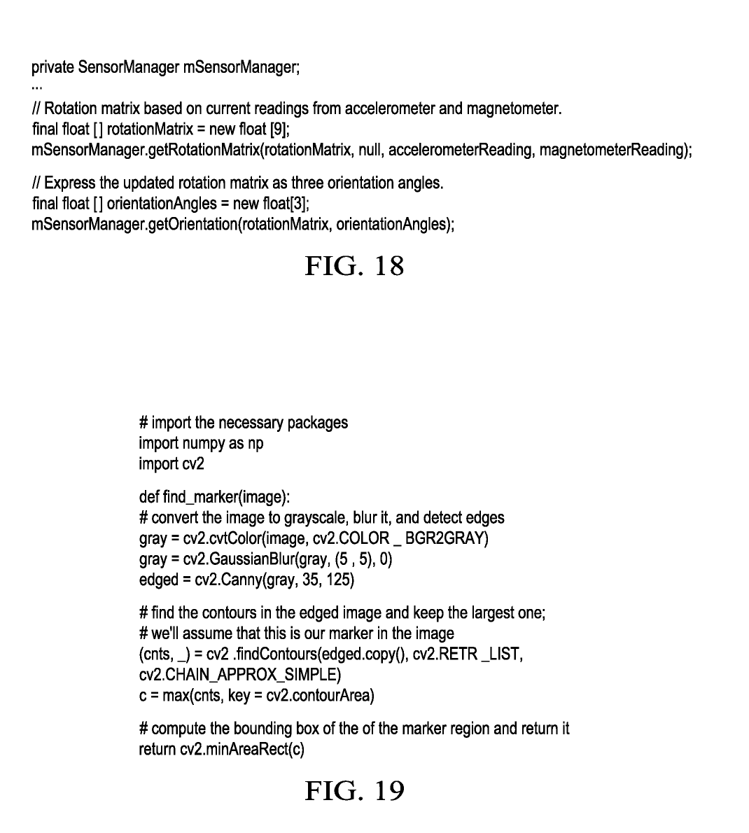

An example of C code used in a preferred embodiment to obtain sensor readings and calculate azimuth, pitch, roll, and magnetic field is shown in FIG. 18.

At step 1038, the technician device send a values for the distance to target, azimuth, pitch, roll, and magnetic field to server 210.

At step 1040, server 210 queries the campaigns table 609 to receive a set of preferred values for azimuth, pitch, roll, and magnetic field associated with the system number.

At step 1042, the server compares the preferred values for distance to target azimuth, pitch, roll, and magnetic field to the values received from the technician device as follows.

In a preferred embodiment, at step 1042 the distance to target, azimuth, pitch, roll, and magnetic field are compared to the preferred distance to target azimuth, pitch, roll, and magnetic field according to the following equations:

D−D′=Distance to Target Correction Eq. 2

A−A′=Azimuth Correction Eq. 3

R−R′=Roll Correction Eq. 4

MF−MF′=Compass Correction Eq. 5

### Where:

A=Azimuth

A′=Preferred Azimuth

R=Roll

R′=Preferred Roll

MF=Magnetic Field

MF′=Preferred Magnetic Field

D=Distance to Target

D′=Preferred Distance to Target

At step 1043, the server generates instructions which include the corrections in the position of the camera for the technician device. The instructions include a distance to target correction, the azimuth correction, the roll correction, and the compass correction.

At step 1044, the correction instructions are sent to the technician device.

At step 1045, the server generates a wireframe image overlay according to the distance to target, azimuth, pitch, roll, and magnetic field received from the technician device. A wireframe image is returned from table 609. The wireframe image is a line drawing that forms a picture of the display for the appropriate system number. In a preferred embodiment, the wireframe image overlay is a wireframe picture of the front of the display. In the wireframe image overlay, the wireframe picture of the display is “shifted” to show the lateral distance away from the preferred position of the display in the image. This way, when the wireframe image overlay is displayed on the technician device, along with the real time camera display, it shows a “ghost image” of the preferred position of the display in the preferred position alongside the actual image of the physical display shown by the camera on the technician device, as will be further described.

In a preferred embodiment, the lateral shift distance is derived according to the following formula:

$$Horizontal Shift = \frac{{Lon}_{A} + {Lon}_{P}}{Cos ( 90 - ∝ )} \qquad Eq . 6$$

### Where:

Lon_{A}=GPS Longitude of Technician Device

Lon_{P}=Preferred Longitude of Display

∝=Compass Angle from Magnetic Field

At step 1046, the wireframe image overlay is sent from the server to the technician device.

At step 1048, the technician device activates the camera and displays a set of centered crosshairs.

At step 1052, the technician device displays a camera image.

At step 1054, the technician device displays the wireframe image overlay on superimposed the camera image. The corresponding instructions are also displayed simultaneously to the user to move the physical display to the position shown by the wireframe image overlay.

At step 1055, when the physical display has been moved to the position of the wireframe image, the technician device receives the signal from the user signaling correction completion.

At step 1056, upon entering of the correction completion signal the technician device removes the display wireframe image overlay from the camera image and displays crosshairs.

At step 1057, a trigger input is received at the technician device when the crosshairs have been recentered on the physical display.

At step 1060, the technician device gets a current azimuth reading.

At step 1062, the technician device gets a current pitch reading.

At step 1064, the technician devices gets a current roll reading.

At step 1065, the technician devices gets a current distance to target reading.

At step 1066, the distance to target, azimuth, pitch, and roll information is sent to server 210.

At step 1068, the information from the technician device is compared to the preferred information for these parameters according to Equations 2-5 to determine if each is within a set of predetermined tolerances. If the parameters are within predetermined tolerances then an acknowledgement is generated at step 1070. In a preferred embodiment, the predetermined tolerance for each parameter is ±20%. If not, a set of corrections is generated and sent to the technician device.

At step 1074, the acknowledgement or corrections is sent to the technician device.

At step 1076, the acknowledgement or corrections is displayed.

At step 1078, the server returns a stocking wireframe image from table 609. In a preferred embodiment, the stocking wireframe image shows the preferred position of the products in the display. The stocking wireframe image may be scaled according to the distance to target information received in step 1066.

At step 1080, the stocking wireframe image is sent from the server to the technician device.

At step 1082, the stocking wireframe image is displayed by the technician device. In a preferred embodiment, the stocking wireframe image is used by the technician to stock the display correctly.

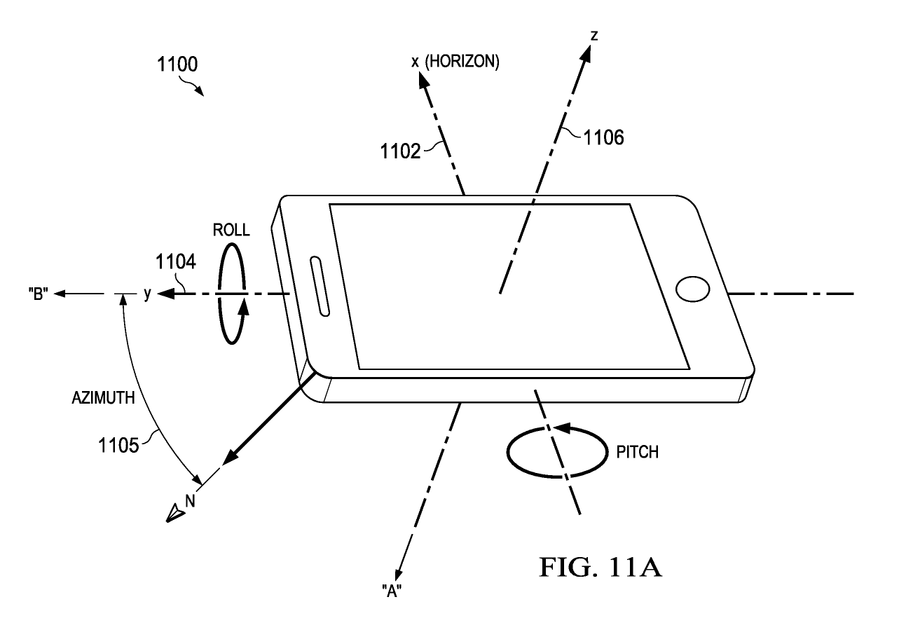

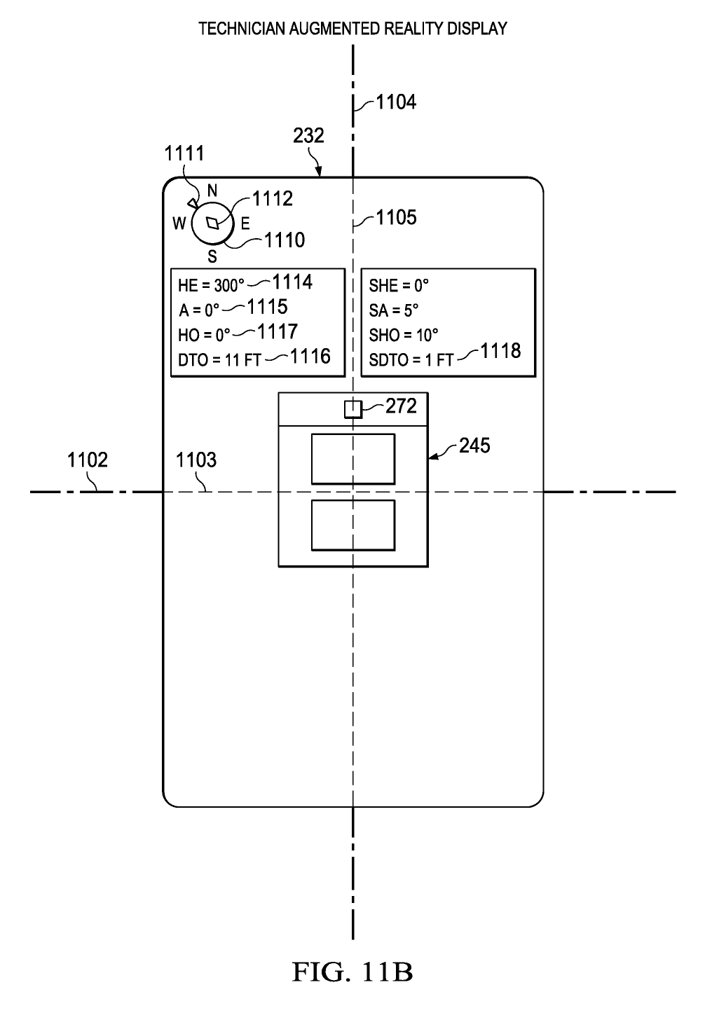

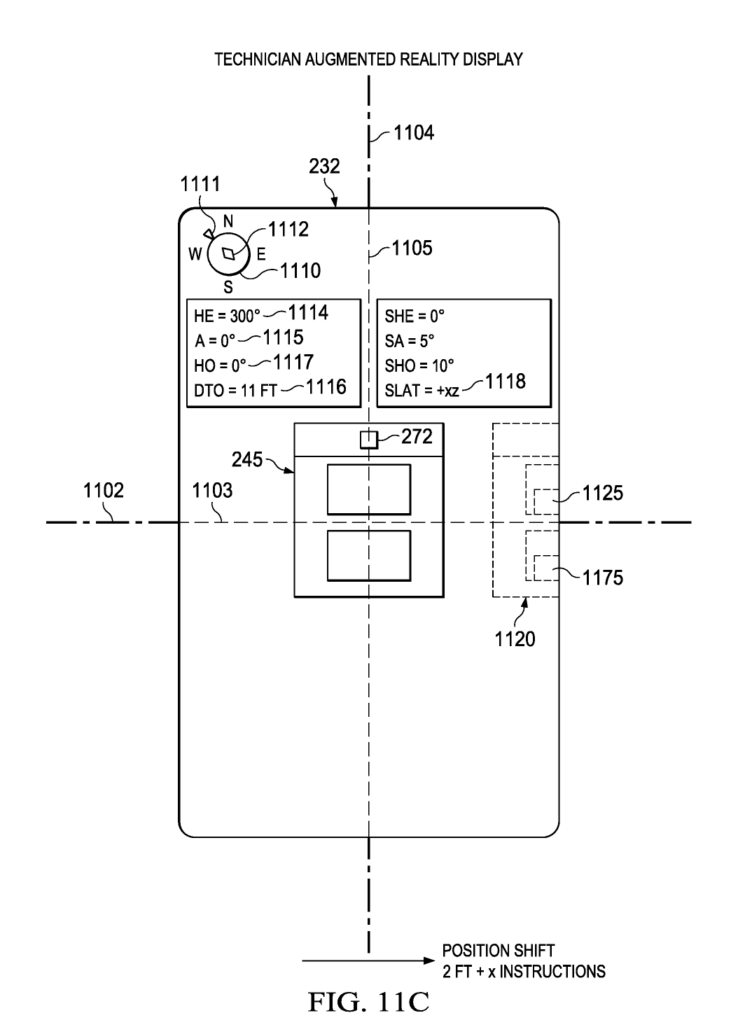

Referring to FIG. 11A, a coordinate system 1100 for the technician device will be described.

Technician device 232 is shown in a position where camera 567 is hidden. Camera 567 faces in the direction “−z” along axis 1106. In use, axis 1106 is positioned at the preferred distance to target and directed perpendicularly to the front face of the physical display according to direction “A”.

Axis 1102 is the “+x” axis or “pitch”. When the camera is directed toward the physical display at distance to target, axis 1102 is held parallel with the horizon. In a preferred embodiment, the roll angle should be close to 0.

Axis 1104 is defined as the “+y” axis or “roll”. In a preferred embodiment, the technician device is in proper position in when direction “B” is exactly vertical. Hence, in a preferred embodiment the azimuth angle 1105 should be close to 0.

The magnetic field and compass reading is derived about axis 1104.

Referring to FIG. 11B, the technician augmented reality to display is shown.

Technician device 232 is directed along axis 1106 in direction “z” directly into the page and perpendicular to the face of display 245. Axis 1102 and 1104 are aligned to crosshairs 1103 and 1105, which are positioned in the center of display 245. When in position, the compass display 1110 provides a graphic display of actual heading 1112 and preferred heading 1111. Heading box 1114 is displayed showing a numerical bearing in degrees. Distance to target information is provided in distance to target display 1116. Required shift information is provided in shift display 1118.

Azimuth display 1115 shows the amount of deviation of the device from vertical to axis 1106.

Horizon display 1117 shows the amount of deviation from axis 1102 to the horizon.

Referring to FIG. 11C, an example of the technician augmented reality display is shown including the wireframe image overlay. Wireframe image overlay 1120 appears as a “ghosted image” in the display. In this example, it is shown offset by a positive shift along axis 1102 of about 2 ft. The distance is shown along the direction axis 1102 in shift display 1118.

Stocking wireframe images 1125 and 1175 are shown to simulate proper product stocking positions.

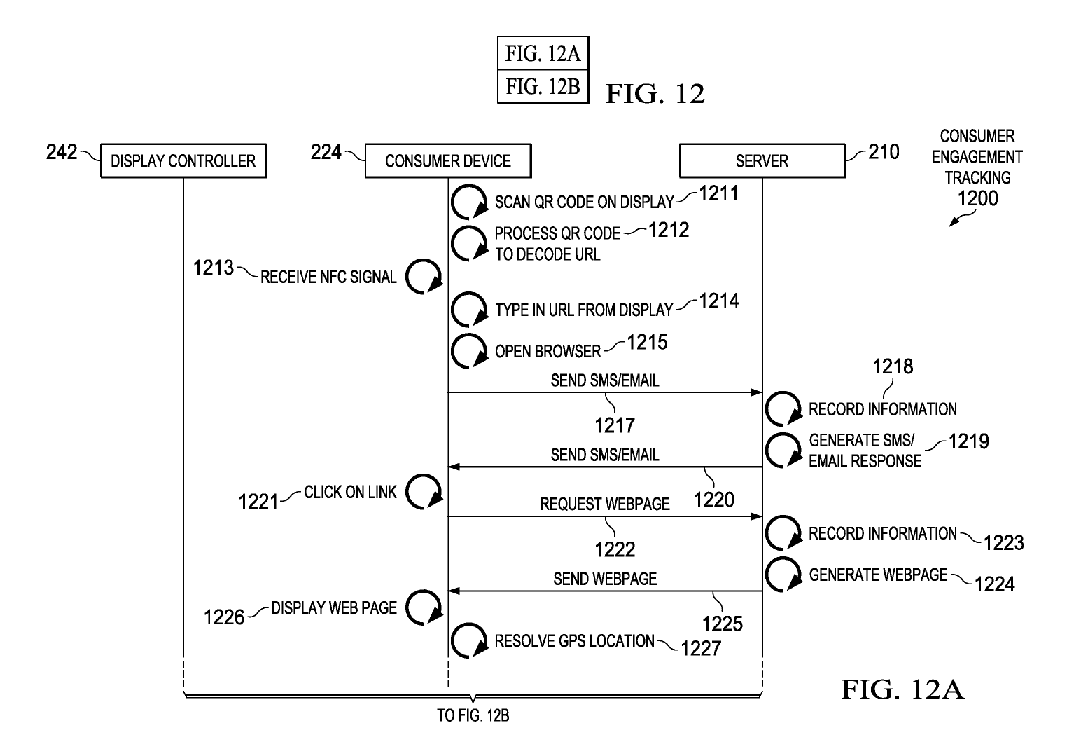

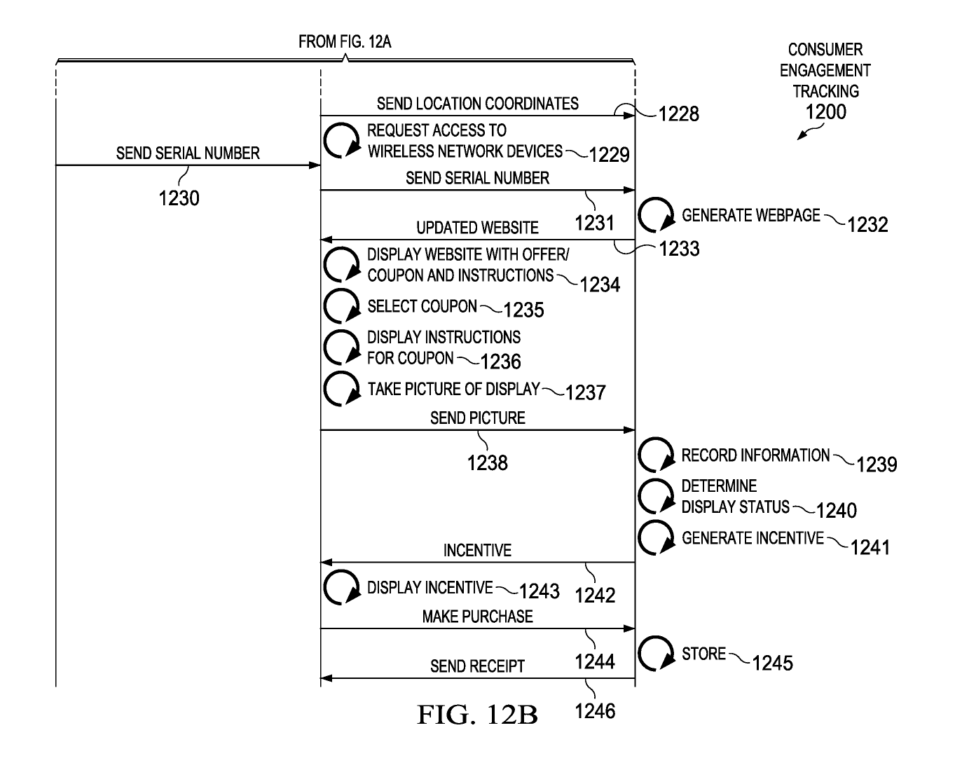

Referring to FIGS. 12A and 12B, sequence 1200 describes the steps performed by the system when a consumer device interacts with display 240.

Optionally at step 1211, a QR code is scanned by consumer device 224.

Optionally at step 1212, after scanning the QR code, the QR code is processed by consumer device 224 to resolve a uniform resource locator (URL).

Optionally, at step 1213, the consumer device receives an NFC signal from NFC tag 377.

Optionally at step 1214, a URL printed on the display is entered into the browser application on consumer device 224.

At step 1215, a web browser application is opened on consumer device 224. The browser can be opened automatically in response to resolving the URL or upon receiving the NFC signal.

Optionally, at step 1217, an SMS text message or email message is sent to the server requesting a webpage.

At step 1218, information is recorded by server 210 in response to receiving the request for the webpage. The recorded information includes an identifier for consumer device 224 and a timestamp relating to when the request was sent.

Optionally, at step 1219, a return text message or email is generated including an active link to the webpage.

Optionally, at step 1220, the return text message or email is sent to consumer device 224.

Optionally, at step 1221, the consumer device opens the text message or email and a link is selected from the message or email.

At step 1222, the user device requests the webpage.

At step 1223, the server records the information in memory.

At step 1224, a HTML webpage is generated by server 210 based on the information received from consumer device 224.

At step 1225, the webpage generated by server 210 is sent from server 210 and is received by consumer device 224.

At step 1226, the webpage is displayed in the browser.

At step 1227, the GPS location of consumer device 224 is resolved and stored.

At step 1228, the GPS location of consumer device 224 sent to server 210.

At step 1229, a request to access wireless network devices near consumer device 224 is displayed by consumer device 224.

Optionally, at step 1230, the serial number is sent by display controller 242 to the consumer device 224. The serial number is the unique ID coded into the beacon signal.

Optionally, at step 1231, the serial number is received consumer device 224 and forwarded to server 210.

At step 1232, an updated version of the webpage is generated by server 210. At step 1233, the webpage is sent from server 210 to consumer device 224. The website is updated based on one either the location of consumer device 224 or the serial number or both.

At step 1234, the website is displayed on consumer device 224. The webpage can include an incentive or coupon and instructions for using the incentive.

At step 1235, an incentive is selected from one of the incentives displayed by consumer device 224.

At step 1236, the instructions for the incentive are displayed. In one embodiment, the instructions can require that a picture of the display be taken by the consumer device and transmitted to server 210 in order to receive the incentive.

At step 1237, a picture of the display is taken with consumer device 224.

At step 1238, the picture is sent from consumer device 224 and received by server 210.

At step 1239, information is recorded by server 210 as an event in the database. The information includes an identifier about consumer device 224, the location of consumer device 224, the picture taken by consumer device 224, timestamps relating the picture and the signal strength of the serial number when it was received.

At step 1240, the status of the display is determined by server 210 based on the picture, the location information from consumer device 224, and/or the serial number that was received by consumer device 224.

At step 1241, an incentive is generated by server 210. In a preferred embodiment, the incentive is dictated by the campaign. In another embodiment, the incentive is generated based on the display type, the identity of the consumer, the identity of the consumer device, the amount of time taken by the consumer to take the picture, the product in the display, the time of day or how much product is left in the display as indicated by the optical sensors on the display.

At step 1242, the incentive is sent from server 210 to consumer device 224.

At step 1243, the incentive is displayed on consumer device 224.

Optionally, at step 1244 the consumer device can purchase a product located on the display through various known mobile wallet protocols.

At step 1245, server 210 stores the purchase request.

At step 1246, server 210 sends a receipt for the mobile purchase to the consumer device.

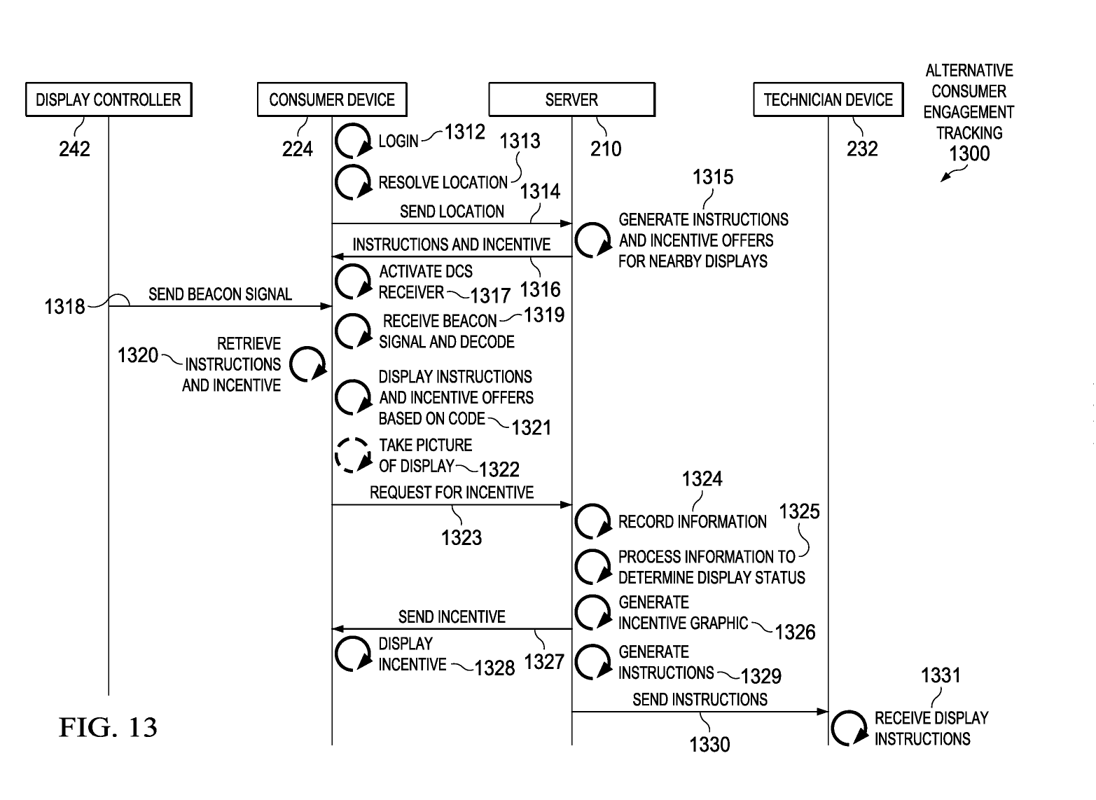

Referring to FIG. 13, sequence 1300 describes alternate steps performed by the system when the consumer device interacts with the system.

At step 1312, a user logs into the application running on consumer device 224 and an authentication procedure is performed.

At step 1313, the location coordinates of consumer device 224 are resolved.

At step 1314, the location coordinates are sent to server 210.

At step 1315, instructions and incentives are generated by server 210. In one embodiment, the incentives are generated based information from consumer device 224, including the location of consumer device 224.

At step 1316, the instructions and incentives are sent from server 210 to consumer device 224.

At step 1317, a beacon receiver is activated on consumer device 224 by the consumer application.

At step 1318, the display controller sends a beacon signal.

At step 1319, the beacon signal is received and decoded to determine a serial number. In a preferred embodiment, the beacon signal is matched to a table containing serial numbers of all systems in the campaign.

At step 1320, instructions and incentives are retrieved from local memory in consumer device 224. In a preferred embodiment, the instructions and incentives are stored in campaigns table 609 according to the serial number.

At step 1321, instructions and incentives are displayed on the consumer device. The instructions and incentives are based on the serial number received from display controller 242 and the GPS location of the display or consumer device 224 or both.

Optionally at step 1322, a picture of display 240 is taken by consumer device 224. In one embodiment, the picture is taken with the consumer application that also provides a timestamp of when the picture is taken. In one embodiment, the incentives provided are increased when a recent picture is transmitted to the server.

At step 1323, a request for an incentive is sent from consumer device 224 to server 210.

At step 1324, information received from consumer device 224 is recorded by server 210 in database 215. The information recorded includes identifiers for the consumer device, the picture of the display and timestamps for the picture and the time the request was sent.

At step 1325, the information request is processed by server 210. The processing determines the status of the display, such as the amount of product currently on the display, whether the correct products are on the display, whether the display needs to be restocked, whether the display needs to be repaired or cleaned, and whether the display needs to be retired.

At step 1326, incentives are generated based on the information provided by consumer device 224 and the processing of the information by server 210. In one embodiment, when display 240 is determined by server 210 to be understocked from the picture of the display, the value of the incentive is increased. If the display is full, then the value of the incentive is decreased. Of course, other incentive changes are possible. In one embodiment, when the picture and request for the incentive are sent within a predetermined elapsed time period, then the value of incentive is increased.

At step 1327, the incentive is sent to consumer device 224 from the server 210.

At step 1328, the incentive is displayed on consumer device 224.

At step 1329, the server generates instructions for technician device 232 based on the status of display 240 as indicated in the picture. The instructions can include instructions regarding stocking or maintenance of the display. At step 1330, the instructions are sent to technician device 232. At step 1331, technician device 232 receives the instructions and displays them.

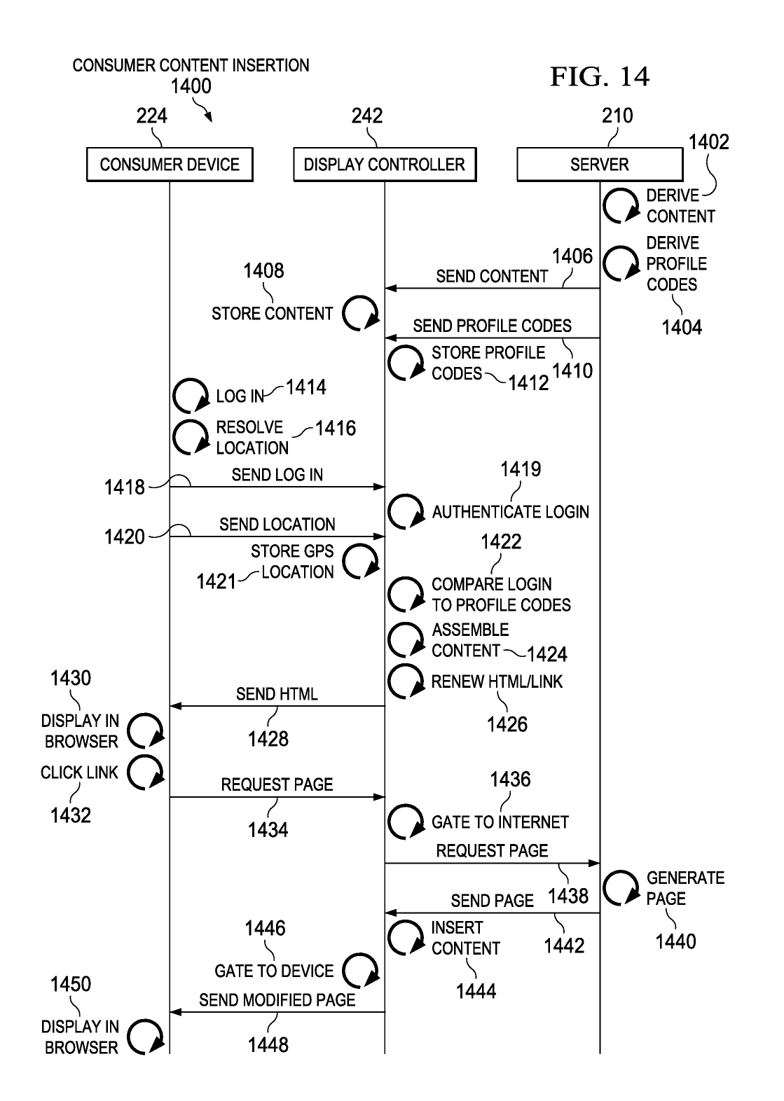

Referring then to FIG. 14, sequence 1400 describes the steps performed when a consumer device receives controlled content from the system through use the router functions of display controller 242.

At step 1402, is a set of advertising content is derived by server 210. A preferred form of the controlled content can be several different HTML webpages.

At step 1404, the server derives a set of profile codes. In a preferred embodiment, profile codes divide consumer profiles into four groups, coded 1-4, indicating the likelihood that that particular consumer will purchase a particular product. The controlled content is different for each of the profile codes.

At step 1406, server 210 sends the content to display controller 242.

At step 1408, display controller 242 stores the content.

At step 1410, server 210 sends the profile codes to display controller 242.

At step 1412, display controller 242 stores the profile codes.

At step 1414, consumer device 224 receives an authentication request from a user to login.

At step 1416, consumer device 224 resolves its GPS location. In a preferred embodiment, the location resolved using GPS coordinates.

At step 1418, the login information is sent to display controller 242.

At step 1419, the login is authenticated by display controller 242 by, for example, comparing the login to a table of authorized users.

At step 1420, consumer device 224 sends the GPS location information to display controller 242.

At step 1421, display controller 242 stores the GPS location and associates it with the login authentication in a temporary file.

At step 1422, display controller 242 compares the login information to the profile codes.

At step 1424, display controller 242 selects the content associated with the particular profile code associated with the login.

At step 1426, display controller 242 creates an active link to related advertising and embeds it in the assembled content.

At step 1428, the assembled HTML file including the link is sent to consumer device 224.

At step 1430, consumer device 224 renders the page in a browser.

At step 1432, consumer device 224 selects the active link in the page.

At step 1434, the page is requested from display controller 242.

At step 1436, display controller 242, acting as a router, gates the request for the page to server 210. The request for the page is made at step 1438.

At step 1440, server 210 generates additional web pages.

At step 1442, those pages are sent to display controller 242.

At step 1444, display controller 242 inserts additional content into the page.

At step 1446, display controller 242, acting as a router, gates the page to consumer device 224.

At step 1448, the modified page is sent to consumer device 224.

At step 1450, consumer device 224 displays the page in the browser.

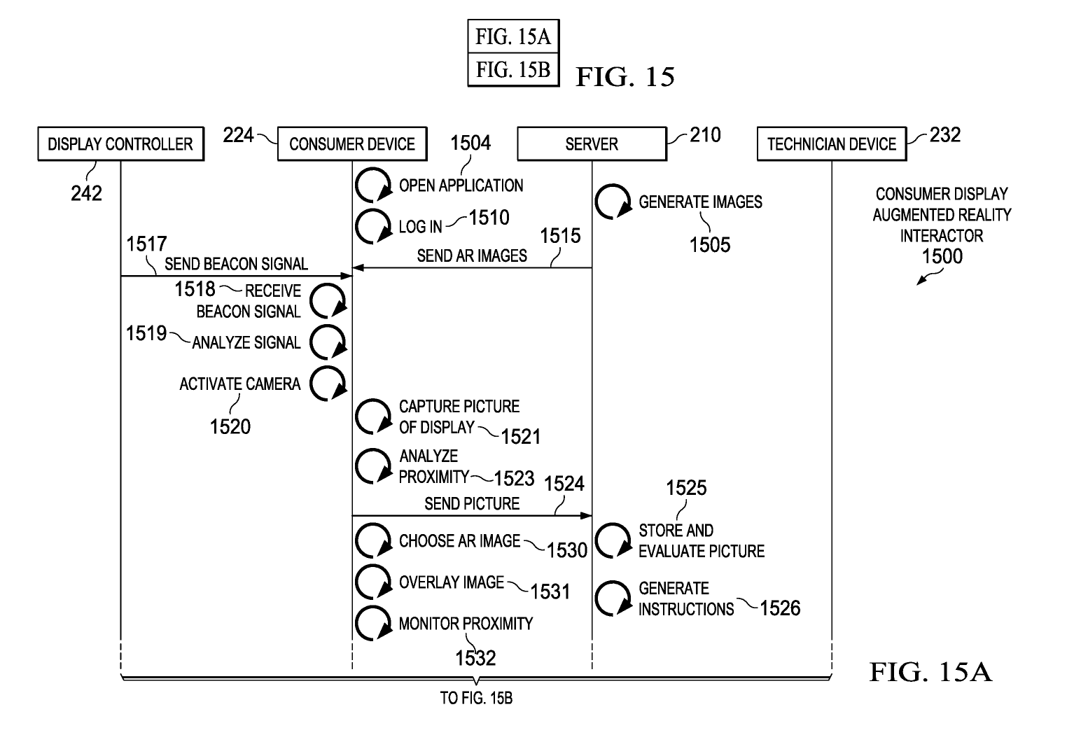

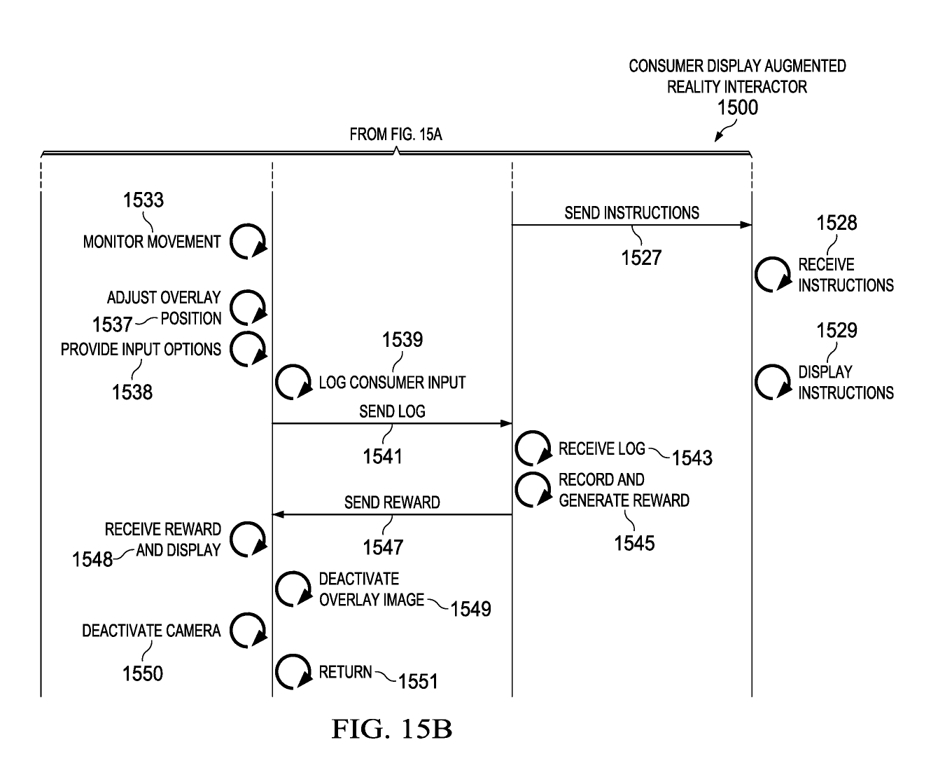

Referring to FIGS. 15A and 15B, sequence 1500 describes the steps performed when a consumer device interacts with the system using the augmented reality features of the consumer display interactor.

At step 1504, an application is opened. At step 1505, server 210 generates a series of augmented reality (AR) images. The AR images, in a preferred embodiment, consist of three different cartoon images. In one embodiment, the AR images can be short mp4 video files that are looped to create a moving image.

At step 1510, a login program is executed. At step 1515, server 210 downloads the augmented reality images to consumer device 224.

At step 1517, display controller 242 transmits an omnidirectional beacon signal. At step 1518, consumer device 224 receives the beacon signal. At step 1519, consumer device 224 analyzes the signal strength of the beacon signal. In a preferred embodiment, signal strength is compared to a calibration table which resolves the signal strength into an approximate distance from the display.

If the beacon signal is within a certain predetermined strength, consumer device 224 is assumed to be a certain distance from the display. At step 1520, the device activates the camera and provides a visual notification on the screen. In a preferred embodiment, the user notification includes instructions to direct the camera toward the display so that target marker 272 can be optically recognized.

At step 1521, the camera captures a picture of the display.

At step 1523, once the target marker is recognized, consumer device 224 analyzes the proximity of consumer device 224 based on the size of the target marker. In a preferred embodiment, proximity is analyzed by comparing the number of pixels in the target marker image to a table which provides an approximate distance from the display based on the number of pixels in the frame. An example of python code that can be used to accomplish this step is included in FIG. 19. In another preferred embodiment, the signal strength from the beacon is analyzed for proximity. A table is consulted where signal strength is compared to relative distances. If the strength of the signal is high, then the distances in the table are shorter, which indicate the closeness of consumer device 224 to display 240.

At step 1524, consumer device 224 sends the picture to server 210. At step 1525, server 210 stores and evaluates the picture for damage, required maintenance, and stocking level. In a preferred embodiment, the image of the display in the picture is compared side by side to an ideal picture of the display by a system operator who then manually enters a set of remedial instructions.

At step 1526, a status message and instructions are generated. At step 1527, the message and instructions are sent to technician device 232.

At step 1528, the technician device receives and stores the message and instructions. At step 1529 the technician device displays the message and instructions, along with a serial number identifying the display involved.

At step 1530, based on the proximity of the consumer to the display, consumer device 224 chooses an AR image from memory. In a preferred embodiment, an AR image is chosen to incentivize the consumer to approach the display and interact with it. For example, at a distance of ten meters the display comprises an incentive for a free product. At a distance of five meters the incentive is for two free products. At a distance of one meter the incentive is for three free products. Similarly, colors and image types can change to represent different products or characters based on the proximity of consumer device 224 to the display. In the same way, the AR images may be changed according to the consumer identity, GPS location or the time of day.

At step 1531, the AR image is overlaid onto the camera image by consumer device 224, as will be further described.

At step 1532, the proximity of consumer device 224 to the display is monitored. If consumer device 224 exceeds a predetermined distance from the display, then the overlay image is discontinued. In a preferred embodiment, the beacon signal is monitored for signal strength in order to determine proximity. If the beacon signal falls below a certain predetermined signal strength, then it is assumed that consumer device 224 is too far away from the display for the consumer to maintain interest. Hence, the image is discontinued.

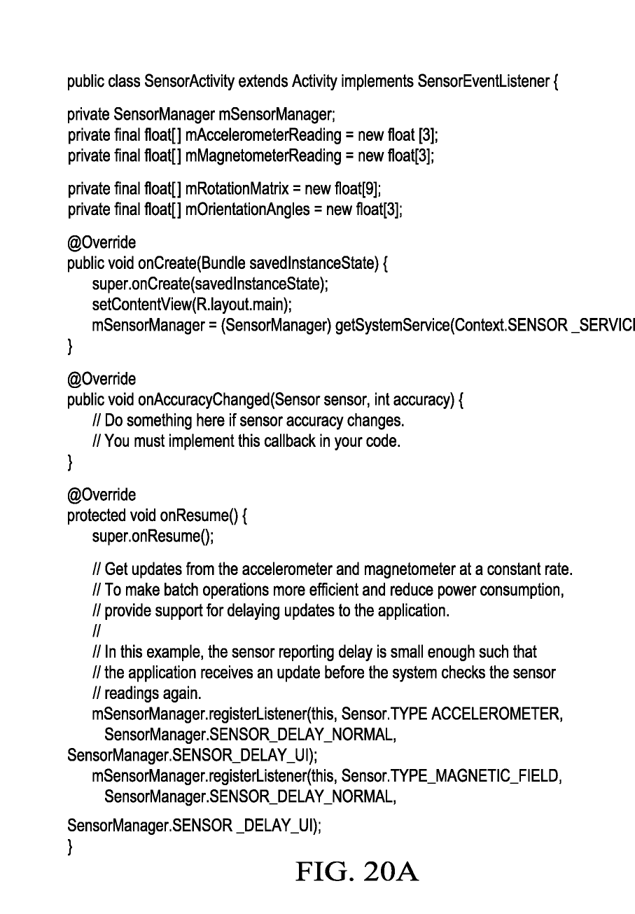

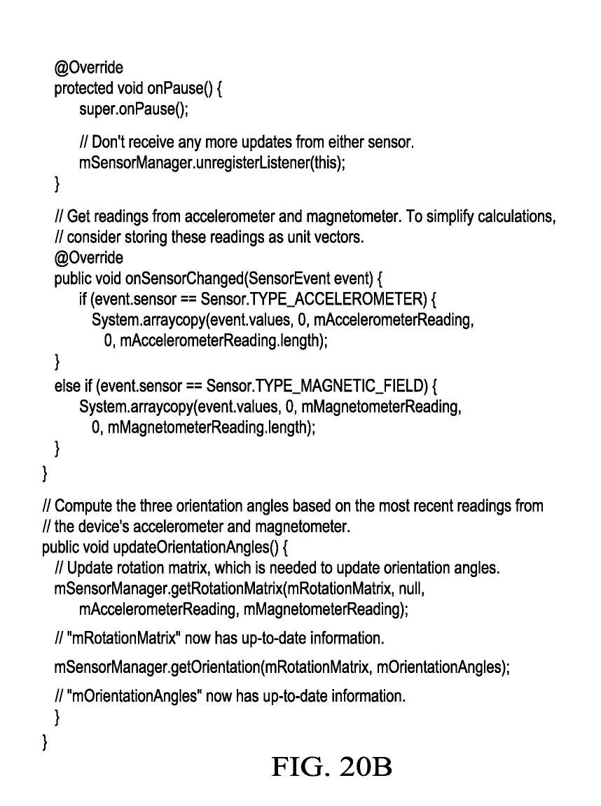

At step 1533, consumer device 224 monitors its onboard sensors in order to determine relative movement. The sensors provide information related to translation, rotation and acceleration of consumer device 224. A preferred embodiment of C code used to determine relative movement of the device is shown in FIGS. 20A and 20B. This information is used by consumer device 224 to move the overlay image relative to the camera display in order to maintain the illusion of a stationary object at or near the display image. At step 1537, the overlay position is adjusted to match the sensor information. At step 1538, consumer device 224 displays input options for the consumer.

At step 1539, consumer device 224 logs the consumer input. At step 1541, consumer device 224 sends the input log to server 210. At step 1543, server 210 receives the input log. At step 1545, server 210 generates an incentive or reward based on the consumer input. At step 1547, server 210 sends the incentive information to consumer device 224. At step 1548, consumer device 224 receives the incentive and displays it. At step 1549, consumer device 224 deactivates the overlay image. At step 1550, consumer device 224 deactivates the camera. At step 1551, consumer device 224 returns to monitoring for beacon signals and waits for additional proximity information.

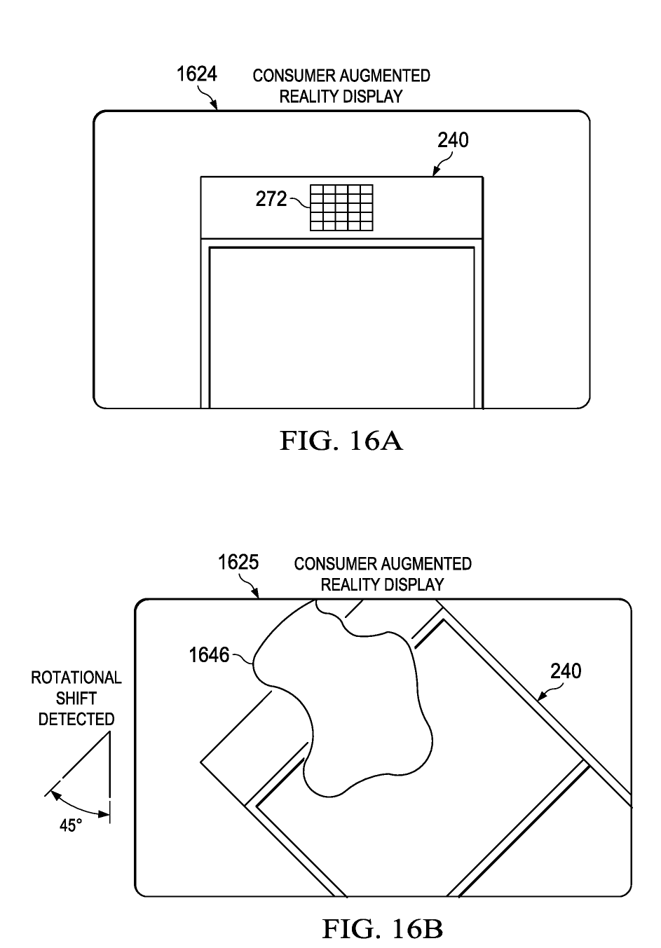

Referring to FIG. 16A, image 1624 is the display of consumer device 224 in camera display mode. Consumer device 224 is aimed at display 240 and generates a digital video image of display 240 and target graphic 272.

Referring to FIG. 16B, consumer device 224 is shown displaying image 1625, which includes AR image 1646 as a result of step 1529 in FIG. 15B. In this embodiment, the virtual image is chosen to overlap display target 272. The figure shows that consumer device 224 has been rotated approximately 45 degrees clockwise resulting in a rotation of the image of display 240 on the screen of consumer device 224. During movement, AR image 1646 is rotated and translated based on relative position information of the on board sensors so as to maintain station over display target 272.

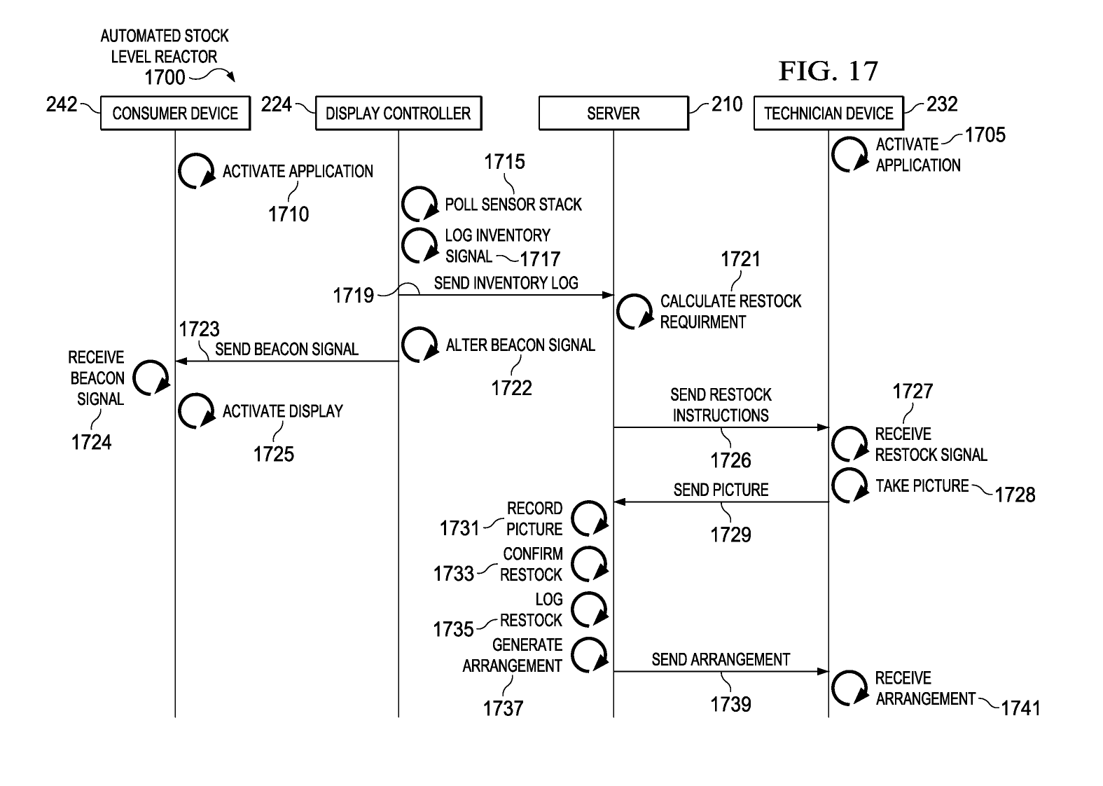

Referring to FIG. 17, method 1700 is described in which a stock level reaction is sensed by the display and translated into instructions to the technician device.

At step 1705, technician device 232 activates an application. At step 1710, consumer device 224 activates an application.

At step 1715, display controller 242 polls sensor stack 417. An inventory signal is received and stored at step 1717. At step 1719, the inventory signal is sent to server 210. At step 1721, server 210 calculates a restock requirement based on the inventory signal. Upon a change in the inventory signal, at step 1722, display controller 242 alters the intensity of the beacon signal. In one preferred embodiment, as the inventory is reduced, the beacon signal is increased to attract additional consumers with an additional perimeter size. At step 1723, the beacon signal is sent to consumer device 224. At step 1724, consumer device 224 receives the beacon signal. At step 1725, the application activates a display based on the receipt of the beacon signal. In a preferred embodiment, the display includes instructions to the consumer as to the increased value of incentives based on the stock level in the display. At step 1726, server 210 sends a set of restock instructions to technician device 232. At step 1727, technician device 232 receives the restock instructions. At step 1728, technician device 232 takes a picture of the restocked display. At step 1729, the technician device sends the picture to server 210. At step 1731, server 210 records the picture. At step 1733, server 210 confirms that the display has been restocked. At step 1735, server 210 logs the restock occurrence in the events database. At step 1737, server 210 generates a restock arrangement request. At step 1739, server 210 sends the restock arrangement signal to technician device 232. At step 1741, the technician device receives and displays the restock arrangement signal.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

1. A display system comprising:
a container structure;
a display controller removably fixed to the container structure;
a beacon signal generator operatively connected to the display controller;
a memory operatively connected to the display controller and further comprising a set of instructions that when executed by the display controller cause the display system to:
activate the beacon to send a first beacon signal;
adjust the first beacon signal in response to a stimulus signal to form a second beacon signal; and,
activate the beacon to send the second beacon signal.

2. The display system of claim 1 further comprising:
a wireless networking module operatively connected to the display controller; and,
wherein the memory further comprises instructions that when executed by the display controller cause the system to:
establish a wireless network connection between the display controller and a server with the wireless networking module.

3. The display system of claim 2 further comprising:
a global positioning system module operatively connected to the display controller; and,
wherein the memory further comprises instructions that when executed by the display controller cause the system to:
resolve a location of the container structure using the global positioning system module; and,
send a serial number, stored in the memory, and the location to the server.

4. The display system of claim 2 wherein the memory further comprises instructions that when executed by the display controller cause the system to:
receive, from the server, the stimulus signal.

5. The display system of claim 4 wherein stimulus signal indicates a user proximity to the container structure.

6. The display system of claim 2 further comprising an inventory sensor operatively connected to the display controller and fixed to the container structure; and,
wherein the memory further comprises instructions that when executed by the display controller cause the system to:
poll the inventory sensor for an inventory signal; and,
generate the stimulus signal based on the inventory signal.

7. The display system of claim 6 wherein the memory further comprises instructions that when executed by the display controller cause the system to:
generate an inventory log based on the inventory signal; and,
send the inventory log to the server using the wireless networking module.

8. The display system of claim 1 further comprising a visual display supported by the container structure and operatively connected to the display controller; and,
wherein the memory further comprises instructions that when executed by the display controller cause the system to:
send an image signal to the visual display upon receipt of the stimulus signal.

9. A system for deploying, maintaining, and retiring a display structure, the system comprising:
a technician device including a first memory and a first processor;
a server, connected to the technician device through a network, including a second memory and a second processor;
the first memory and the second memory further comprising instructions that when executed cause the system to:
display, by the technician device of a set of instructions related to the display structure;
receive, by the technician device, a first picture of the display structure;
send, by the technician device to the server, the first picture;
make, by the server, a first comparison of a second picture of the display structure, stored in the second memory, to the first picture;
generate, by the server, a first message based on the comparison; and
send, by the server to the technician device, the first message.

10. The system of claim 9 further comprising a reporting processor, having a third memory and a third processor, operatively connected to the server by the network; and
wherein the second memory further comprises instructions that when executed cause the system to:
send a second message to the reporting processor based on the comparison.

11. The system of claim 9 wherein the first memory and the second memory further comprise instructions that when executed cause the server to:
send, by the technician device to the server, a deployment location;
made, by the server, a second comparison of a required location, stored in the second memory, to the deployment location;
generate, by the server to the technician device, a second message based on the second comparison.

12. The system of claim 9 wherein the first memory and the second memory further comprise instructions that when executed cause the system to:
display, by the technician device, a preferred location of the display structure.

13. The system of claim 9 further comprising a display controller, removably attached to the display structure;
the display controller operatively connected to the technician device and the server by the network;
the display controller having a third processor operatively connected to a third memory; and,
wherein the first memory, the second memory, and the third memory further compromise instructions that when executed cause the system to:
receive, at the technician device from the display controller, a first beacon signal;
make a comparison between the first beacon signal to a second beacon signal stored in the first memory; and,
verify a state of the system based on the comparison.

14. The system of claim 9 wherein the step of display further comprises displaying, by the technician device, a set of instructions related to one of the group of a deployment of the display structure, a maintenance of the display structure, a stocking the display structure and a retirement of the display structure.

15. The system of claim 9 wherein the step of display of the set of instructions further comprises displaying a video.

16. The system of claim 13 wherein the first memory, second memory, and the third memory further comprise instructions that when executed cause the system to:
establish, by the display controller, a wireless network connection to the server;
acquire, by the display controller a first set of GPS coordinates of the display controller;
send, by the display controller to the server, the first set of GPS coordinates;
make, by the server, a comparison of the first set of GPS coordinates to a second set of GPS coordinates stored in the third memory; and,
send, by the server, to the technician device, a message based on the comparison.

17. The system of claim 13 wherein the first memory, the second memory, and the third memory further comprise instructions that when executed cause the system to:
generate, by the technician device, a status message;
send, by the technician device to the server, the status message; and,
verify, by the server, a state of the display structure based on the status message.

18. A system for retirement tracking of an in-store display, the system comprising:
a technician device, operatively connected to a network, including a first memory and a first processor;
a server, operatively connected to the technician device through the network, including a second memory and a second processor;
the first memory and the second memory comprising a set of instructions that when executed cause the system to perform the steps of:
identifying, by the technician device, the in-store display with a visual display identifier on the in-store display;
sending, by the technician device to the server, the visual display identifier and a retirement location resolved by the technician device;
verifying, by the server, the retirement location of the technician device and the visual display identifier;
sending, by the server to the technician device, a set of retirement instructions that are based on the retirement location and the visual display identifier and that include text and a video;
displaying, by the technician device, the set of retirement instructions;
sending, by the technician device to the server, a status report that includes a technician device identifier, a picture of the in-store display, and the retirement location;
verifying, by the server, a state of the in-store display based on the status report;
sending, by the server to the technician device, a confirmation of the disassembly of the in-store display; and,
displaying, by the technician device, the confirmation.

19. The system of claim 18 further comprising:
a display controller, operatively connected to the technician device and the server by network, including a third memory and a third processor;
the first memory, the second memory, and the third memory comprising a set of instructions that when executed cause the system to perform the steps of:
deactivating the display controller; and,
sending, by the server to a report device, a retirement report that includes a picture of the in-store display controller.

20. A system for display maintenance and restock tracking of an in-store display, the system comprising:
a technician device that is operatively connected to a network and that includes a first memory and a first processor;
a server that is operatively connected to the technician device through the network and includes a second memory and a second processor;
the first memory and the second memory comprising a set of instructions that when executed cause the system to perform the steps of:
sending, by the technician device to the server, a request for maintenance instructions that includes an identifier of the technician device and a maintenance location of the technician device;
sending, by the server to the technician device, the maintenance instructions that include an activity to be performed by the technician using the technician device;
sending, by the technician device to the server, a status report that includes the technician device identifier, a picture of the in-store display, the maintenance location, and the serial number received from the display controller;
generating, by the server, additional maintenance instructions based on the status of the in-store display determined by the server;
sending, by the server to the technician device, the additional maintenance instructions; and,
displaying, by the technician device, the additional maintenance instructions.

21. The system of claim 20 further comprising:
a display controller operatively connected to the technician device and the server by the network;
the display controller operatively connected to a third memory and a third processor;
the first memory, the second memory, and the third memory comprising a set of instructions that when executed cause the system to perform the steps of:
receiving, by the technician device from the display controller, a serial number that identifies the in-store display;
verifying, by the technician device, a location of the in-store display using the maintenance location of the technician device.

22. A system for augmented reality interaction with an in-store display, the system comprising:
a technician device that is operatively connected to a network and includes a first memory and a first processor;
a server that is operatively connected to the technician device by the network and includes a second memory and a second processor;
the first memory and the second memory comprising a set of instructions that when executed cause the system to perform the steps of:
sending, by the technician device to the server, a location of the technician device;
comparing, by the server, the location of the technician device with a preferred location of the in-store display;
sending, by the server to the technician device, a set of instructions to assemble the in-store display when the location of the technician device is within a predetermined tolerance of the preferred location of the in-store display;
sending, by the technician device to the server, a first set of position readings received in response to a first trigger input and a distance between the in-store display and the technician device;
making a first comparison, by the server, of the first set of position readings to a preferred set of position readings;
making a second comparison, by the server, of the first distance to a preferred distance;
sending, by the server to the technician device, a set of correction instructions to correct a position of the technician device based on the first comparison and the second comparison.

23. The system of claim 22 wherein the first memory and the second memory further comprise instructions that when executed cause the system to perform the steps of:
displaying, by the technician device, a camera image, a wireframe image overlay, and the correction instructions;
sending, by the technician device to the server, a second set of position readings received in response to a second trigger input and a second distance between the in-store display and the technician device;
generating, by the server, an acknowledgement when the second set of position readings and the second distance is within a set of predefined tolerances; and,
sending, by the server to the technician device, the acknowledgment.

24. The system of claim 22 wherein the first memory and the second memory further comprise instructions that when executed cause the system to perform the steps of:
sending, by the technician device to the server, a serial number received from the in-store display;
sending, by the server to the technician device, a stocking wireframe image overlay of the in-store display;
displaying, by the technician device, the camera display, and the stocking wireframe image overlay.

25. A system for consumer engagement tracking with an in-store display, the system comprising:
a consumer device that is operatively connected to a network and includes a first memory and a first processor;
a server that is operatively connected to the consumer device by the network and includes a second memory and a second processor;
the first memory and the second memory comprising a set of instructions that when executed cause the system to perform the steps of:
sending, by the consumer device to the server, a picture of the in-store display;
determining, by the server, a status of the in-store display based on the picture of the in-store display; and,
sending, by the server to the consumer device, an incentive based on the picture of the in-store display.

26. The system of claim 25 further comprising:
a display controller, operatively connected to the consumer device and the server by the network, including a third memory and a third processor;
the first memory, the second memory, and the third memory comprising a set of instructions that when executed cause the system to perform the steps of:
displaying, by the consumer device, a request to access nearby wireless network devices, including the display controller;
sending, by the consumer device to the server, a serial number received from the display controller;
sending, by the server to the consumer device, an updated webpage that is based on the location of the consumer device, and the serial number.

27. The system of claim 25 wherein the first memory, the second memory, and the third memory further comprise instructions that when executed cause the system to perform the steps of:
sending, from the consumer device to the server, a request for a webpage using a uniform resource locator;
sending, by the server to the consumer device, the webpage generated in response to the request for the webpage;
displaying, by the consumer device, the webpage;
resolving, by the consumer device, a location of the consumer device in response to displaying the webpage; and,
sending, by the consumer device to the server, the location of the consumer device.

28. The system of claim 26 wherein the first memory, the second memory, and the third memory further comprise instructions that when executed cause the system to perform the steps of:
sending, by the server to the consumer device, instructions and incentive offers for a set of displays that are within a predefined distance from the consumer device and that includes a display connected to the display controller;
receiving, by the consumer device, the serial number from the display controller connected to the in-store display;
resolving, by the consumer device, the serial number with the instructions and incentive offers to identify an incentive of the incentive offers that is associated with the in-store display connected to the display controller;
displaying, by the consumer device, the instructions and the incentive associated with the in-store display;
taking, by the consumer device, a picture of the in-store display that is connected to the display controller and associated with the incentive; and,
sending, by the consumer device to the server, a request for the incentive.
